(19) United States
(12) Patent Application Publication
(10) Pub. No.: US 2024/0129925 A1
(43) Pub. Date: Apr. 18, 2024

(54) SINGLE DOWNLINK CONTROL INFORMATION SCHEDULING MULTIPLE UPLINK SHARED CHANNELS ACROSS TIME AND FREQUENCY

(71) Applicant: QUALCOMM Incorporated, San Diego, CA (US)

(72) Inventors: Ahmed Attia Abotabl, San Diego, CA (US); Muhammad Sayed Khairy Abdelghaffar, San Jose, CA (US); Abdelrahman Mohamed Ahmed Mohamed Ibrahim, San Diego, CA (US)

(21) Appl. No.: 17/967,715

(22) Filed: Oct. 17, 2022

(51) Int. Cl. H04W 72/12; H04L 5/00; H04W 72/04

(52) U.S. Cl. CPC H04W 72/1289; H04L 5/0092; H04W 72/044

(57) ABSTRACT

A user equipment (UE) may receive, from a network entity, control signaling and a control message. The control signaling may indicate resource allocation tables, including a frequency resource allocation table supporting multiple transmissions across multiple frequency bands corresponding to a single control message and a time resource allocation table supporting multiple transmissions across multiple time intervals corresponding to the single control message. The control message may schedule multiple messages, including a frequency domain resource allocation (FDRA) field and a time domain resource allocation (TDRA) field indicating multiple frequency bands and one or more time intervals according to the time resource allocation table and the frequency resource allocation table. The UE and the network entity may communicate, via the frequency bands and one or more time intervals, multiple wireless messages according to the FDRA and the TDRA.

### FIELD OF TECHNOLOGY

The following relates to wireless communications, including single downlink control information scheduling multiple uplink shared channels across time and frequency.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support single downlink control information (DCI) scheduling multiple uplink shared channels across time and frequency. For example, the described techniques provide for a single DCI that may schedule multiple transmissions (e.g., uplink, downlink, or both), in a single slot, and may schedule such sets of transmissions across multiple slots. For example, the network entity may configure the UE with both a time domain resource allocation (TDRA) table and a frequency domain resource allocation (FDRA) table. Each row of the FDRA table may indicate one or multiple transmissions, and may indicate common parameters (e.g., a modulation and coding scheme (MCS) for each subband in a given slot, or transmission specific parameters for each subband in a given slot, or both. In some examples, the DCI may include an FDRA and TDRA field. The TDRA field may indicate multiple slots, and the FDRA field may indicate multiple subbands. In some examples, the UE may interpret the FDRA and TDRA fields to indicate a single slot in which to transmit on multiple subbands, and the remaining indicated slots may include a single transmission per slot. In some other examples, the UE may interpret the FDRA and TDRA fields to indicate multiple subbands on which to communicate during each of the indicated slots.

The network entity may configure the UE with a threshold (e.g., a maximum) number of transmissions triggered by the DCI. The UE (e.g., and in some examples, the network entity) may drop one or more transmissions (e.g., uplink or downlink) that do not satisfy (e.g., exceed) the threshold. In some examples, the UE may drop scheduled transmissions in frequency first, then in time until the threshold is satisfied, or in time first, then in frequency, until the threshold is satisfied. In some other examples, the UE may drop the scheduled transmissions in order of time counting forward (e.g., from the DCI), or counting backward (e.g., from a reference point such as a next physical uplink control channel (PUCCH)).

A method for wireless communications at a UE is described. The method may include receiving, from a network entity, control signaling indicating a frequency resource allocation table supporting multiple transmissions across multiple frequency bands corresponding to a single control message and a time resource allocation table supporting multiple transmissions across multiple time intervals corresponding to the single control message, receiving, from the network entity, a control message scheduling a set of multiple messages, the control message including a FDRA field and a TDRA field indicating a set of multiple frequency bands and one or more time intervals according to the time resource allocation table and the frequency resource allocation table, and communicating, via the set of multiple frequency bands and the one or more time intervals, the set of multiple messages with the network entity according to the FDRA field and the TDRA field.

An apparatus for wireless communications at a UE is described. The apparatus may include a processor, memory coupled with the processor, and instructions stored in the memory. The instructions may be executable by the processor to cause the apparatus to receive, from a network entity, control signaling indicating a frequency resource allocation table supporting multiple transmissions across multiple frequency bands corresponding to a single control message and a time resource allocation table supporting multiple transmissions across multiple time intervals corresponding to the single control message, receive, from the network entity, a control message scheduling a set of multiple messages, the control message including a FDRA field and a TDRA field indicating a set of multiple frequency bands and one or more time intervals according to the time resource allocation table and the frequency resource allocation table, and communicate, via the set of multiple frequency bands and the one or more time intervals, the set of multiple messages with the network entity according to the FDRA field and the TDRA field.

Another apparatus for wireless communications at a UE is described. The apparatus may include means for receiving, from a network entity, control signaling indicating a frequency resource allocation table supporting multiple transmissions across multiple frequency bands corresponding to a single control message and a time resource allocation table supporting multiple transmissions across multiple time intervals corresponding to the single control message, means for receiving, from the network entity, a control message scheduling a set of multiple messages, the control message including a FDRA field and a TDRA field indicating a set of multiple frequency bands and one or more time intervals according to the time resource allocation table and the frequency resource allocation table, and means for communicating, via the set of multiple frequency bands and the one or more time intervals, the set of multiple messages with the network entity according to the FDRA field and the TDRA field.

A non-transitory computer-readable medium storing code for wireless communications at a UE is described. The code may include instructions executable by a processor to receive, from a network entity, control signaling indicating a frequency resource allocation table supporting multiple transmissions across multiple frequency bands corresponding to a single control message and a time resource allocation table supporting multiple transmissions across multiple time intervals corresponding to the single control message, receive, from the network entity, a control message scheduling a set of multiple messages, the control message including a FDRA field and a TDRA field indicating a set of multiple frequency bands and one or more time intervals according to the time resource allocation table and the frequency resource allocation table, and communicate, via the set of multiple frequency bands and the one or more time intervals, the set of multiple messages with the network entity according to the FDRA field and the TDRA field.

In some examples of the method, apparatuses, and non-transitory computer-readable medium described herein, receiving the control signaling may include operations, features, means, or instructions for receiving a RRC message including the frequency resource allocation table, where the FDRA field includes an index indicating a row in the frequency resource allocation table associated with the set of multiple messages.

In some examples of the method, apparatuses, and non-transitory computer-readable medium described herein, the row in the frequency resource allocation table associated with the index indicates one or more common parameters associated with communicating the set of multiple messages via the set of multiple frequency bands, one or more message-specific parameters associated with communicating each respective message of the set of multiple messages via the set of multiple frequency bands, or a combination thereof.

In some examples of the method, apparatuses, and non-transitory computer-readable medium described herein, receiving the control message may include operations, features, means, or instructions for receiving, in the FDRA field of the control message, an indication of the set of multiple frequency bands that may be associated with a first time interval of a set of multiple time intervals including the one or more time intervals and receiving, in the TDRA field of the control message, an indication of one or more remaining time intervals of the set of multiple time intervals.

In some examples of the method, apparatuses, and non-transitory computer-readable medium described herein, communicating the set of multiple messages may include operations, features, means, or instructions for communicating multiple messages of the set of multiple messages via the set of multiple frequency bands during the first time interval and communicating a remaining one or more messages of the set of multiple messages via a single frequency band of the set of multiple frequency bands across the one or more remaining time intervals of the set of multiple time intervals.

In some examples of the method, apparatuses, and non-transitory computer-readable medium described herein, receiving the control message may include operations, features, means, or instructions for receiving, in the FDRA field of the control message, an indication of the set of multiple frequency bands that may be associated with each of a set of multiple time intervals including the one or more time intervals and receiving, in the TDRA field of the control message, an indication of the set of multiple time intervals.

In some examples of the method, apparatuses, and non-transitory computer-readable medium described herein, communicating the set of multiple messages may include operations, features, means, or instructions for communicating the set of multiple messages via the set of multiple frequency bands during each of the set of multiple time intervals.

Some examples of the method, apparatuses, and non-transitory computer-readable medium described herein may further include operations, features, means, or instructions for receiving control signaling indicating a threshold quantity of messages associated with the control message, where communicating the set of multiple messages may be based on determining that a quantity of the set of multiple messages satisfies the threshold quantity of messages.

Some examples of the method, apparatuses, and non-transitory computer-readable medium described herein may further include operations, features, means, or instructions for dropping one or more messages of a total quantity of messages scheduled by the control message according to the threshold quantity of messages scheduled according to a prioritization of the total quantity of messages that may be based on the one or more time intervals, the set of multiple frequency bands, or a combination thereof.

In some examples of the method, apparatuses, and non-transitory computer-readable medium described herein, a first message occurring a first time offset after the control message may have a higher priority level than a second message occurring a second time offset that may be larger than the first time offset after the control message.

In some examples of the method, apparatuses, and non-transitory computer-readable medium described herein, a first message occurring a first time offset after the control message may have a higher priority level than a second message occurring a second time offset that may be shorter than the first time offset after the control message.

In some examples of the method, apparatuses, and non-transitory computer-readable medium described herein, communicating the set of multiple messages with the network entity may include operations, features, means, or instructions for transmitting a set of multiple uplink transmissions on an uplink shared channel.

In some examples of the method, apparatuses, and non-transitory computer-readable medium described herein, communicating the set of multiple messages with the network entity may include operations, features, means, or instructions for receiving a set of multiple downlink transmissions on a downlink shared channel.

A method for wireless communications at a network entity is described. The method may include transmitting, to a UE, control signaling indicating a frequency resource allocation table supporting multiple transmissions across multiple frequency bands corresponding to a single control message and a time resource allocation table supporting multiple transmissions across multiple time intervals corresponding to the single control message, transmitting, to the UE, a control message scheduling a set of multiple messages, the control message including a FDRA field and a TDRA field indicating a set of multiple frequency bands and one or more time intervals according to the time resource allocation table and the frequency resource allocation table, and communicating, via the set of multiple frequency bands and the one or more time intervals, the set of multiple messages with the UE according to the FDRA field and the TDRA field.

An apparatus for wireless communications at a network entity is described. The apparatus may include a processor, memory coupled with the processor, and instructions stored in the memory. The instructions may be executable by the processor to cause the apparatus to transmit, to a UE, control signaling indicating a frequency resource allocation table supporting multiple transmissions across multiple frequency bands corresponding to a single control message and a time resource allocation table supporting multiple transmissions across multiple time intervals corresponding to the single control message, transmit, to the UE, a control message scheduling a set of multiple messages, the control message including a FDRA field and a TDRA field indicating a set of multiple frequency bands and one or more time intervals according to the time resource allocation table and the frequency resource allocation table, and communicate, via the set of multiple frequency bands and the one or more time intervals, the set of multiple messages with the UE according to the FDRA field and the TDRA field.

Another apparatus for wireless communications at a network entity is described. The apparatus may include means for transmitting, to a UE, control signaling indicating a frequency resource allocation table supporting multiple transmissions across multiple frequency bands corresponding to a single control message and a time resource allocation table supporting multiple transmissions across multiple time intervals corresponding to the single control message, means for transmitting, to the UE, a control message scheduling a set of multiple messages, the control message including a FDRA field and a TDRA field indicating a set of multiple frequency bands and one or more time intervals according to the time resource allocation table and the frequency resource allocation table, and means for communicating, via the set of multiple frequency bands and the one or more time intervals, the set of multiple messages with the UE according to the FDRA field and the TDRA field.

A non-transitory computer-readable medium storing code for wireless communications at a network entity is described. The code may include instructions executable by a processor to transmit, to a UE, control signaling indicating a frequency resource allocation table supporting multiple transmissions across multiple frequency bands corresponding to a single control message and a time resource allocation table supporting multiple transmissions across multiple time intervals corresponding to the single control message, transmit, to the UE, a control message scheduling a set of multiple messages, the control message including a FDRA field and a TDRA field indicating a set of multiple frequency bands and one or more time intervals according to the time resource allocation table and the frequency resource allocation table, and communicate, via the set of multiple frequency bands and the one or more time intervals, the set of multiple messages with the UE according to the FDRA field and the TDRA field.

In some examples of the method, apparatuses, and non-transitory computer-readable medium described herein, transmitting the control signaling may include operations, features, means, or instructions for transmitting a RRC message including the frequency resource allocation table, where the FDRA field includes an index indicating a row in the frequency resource allocation table associated with the set of multiple messages.

In some examples of the method, apparatuses, and non-transitory computer-readable medium described herein, the row in the frequency resource allocation table associated with the index indicates one or more common parameters associated with communicating the set of multiple messages via the set of multiple frequency bands, one or more message-specific parameters associated with communicating each respective message of the set of multiple messages via the set of multiple frequency bands, or a combination thereof.

In some examples of the method, apparatuses, and non-transitory computer-readable medium described herein, transmitting the control message may include operations, features, means, or instructions for transmitting, in the FDRA field of the control message, an indication of the set of multiple frequency bands that may be associated with a first time interval of a set of multiple time intervals including the one or more time intervals and transmitting, in the TDRA field of the control message, an indication of one or more remaining time intervals of the set of multiple time intervals.

In some examples of the method, apparatuses, and non-transitory computer-readable medium described herein, communicating the set of multiple messages may include operations, features, means, or instructions for communicating multiple messages of the set of multiple messages via the set of multiple frequency bands during the first time interval and communicating a remaining one or more messages of the set of multiple messages via a single frequency band of the set of multiple frequency bands across the one or more remaining time intervals of the set of multiple time intervals.

In some examples of the method, apparatuses, and non-transitory computer-readable medium described herein, transmitting the control message may include operations, features, means, or instructions for transmitting, in the FDRA field of the control message, an indication of the set of multiple frequency bands that may be associated with each of a set of multiple time intervals including the one or more time intervals and transmitting, in the TDRA field of the control message, an indication of the set of multiple time intervals.

In some examples of the method, apparatuses, and non-transitory computer-readable medium described herein, communicating the set of multiple messages may include operations, features, means, or instructions for communicating the set of multiple messages via the set of multiple frequency bands during each of the set of multiple time intervals.

Some examples of the method, apparatuses, and non-transitory computer-readable medium described herein may further include operations, features, means, or instructions for transmitting control signaling indicating a threshold quantity of messages associated with the control message, where communicating the set of multiple messages may be based on determining that a quantity of the set of multiple messages satisfies the threshold quantity of messages.

Some examples of the method, apparatuses, and non-transitory computer-readable medium described herein may further include operations, features, means, or instructions for dropping one or more messages of a total quantity of messages scheduled by the control message according to the threshold quantity of messages scheduled according to a prioritization of the total quantity of messages that may be based on the one or more time intervals, the set of multiple frequency bands, or a combination thereof.

In some examples of the method, apparatuses, and non-transitory computer-readable medium described herein, a first message occurring a first time offset after the control message may have a higher priority level than a second message occurring a second time offset that may be larger than the first time offset after the control message.

In some examples of the method, apparatuses, and non-transitory computer-readable medium described herein, a first message occurring a first time offset after the control message may have a higher priority level than a second message occurring a second time offset that may be shorter than the first time offset after the control message.

In some examples of the method, apparatuses, and non-transitory computer-readable medium described herein, communicating the set of multiple messages with the UE may include operations, features, means, or instructions for receiving a set of multiple uplink transmissions on an uplink shared channel.

In some examples of the method, apparatuses, and non-transitory computer-readable medium described herein, communicating the set of multiple messages with the UE may include operations, features, means, or instructions for transmitting a set of multiple downlink transmissions on a downlink shared channel.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects and embodiments are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, embodiments and/or uses may come about via integrated chip embodiments and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range in spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described embodiments. For example, transmission and reception of wireless signals necessarily includes a number of components for analog and digital purposes (e.g., hardware components including antenna, radio frequency (RF)-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes, and constitution.

### BRIEF DESCRIPTION OF THE DRAWINGS

FIG. 1 illustrates an example of a wireless communications system that supports single downlink control information (DCI) scheduling multiple uplink shared channels across time and frequency in accordance with one or more aspects of the present disclosure.

FIG. 2 illustrates an example of a wireless communications system that supports single DCI scheduling multiple uplink shared channels across time and frequency in accordance with one or more aspects of the present disclosure.

FIG. 3 illustrates an example of a wireless communications system that supports single DCI scheduling multiple uplink shared channels across time and frequency in accordance with one or more aspects of the present disclosure.

FIG. 4 illustrates an example of a wireless communications system that supports single DCI scheduling multiple uplink shared channels across time and frequency in accordance with one or more aspects of the present disclosure.

FIG. 5 illustrates an example of a slot duplexing configuration that supports single DCI scheduling multiple uplink shared channels across time and frequency in accordance with one or more aspects of the present disclosure.

FIG. 6 illustrates an example of a timeline that supports single DCI scheduling multiple uplink shared channels across time and frequency in accordance with one or more aspects of the present disclosure.

FIG. 7 illustrates an example of a timeline that supports single DCI scheduling multiple uplink shared channels across time and frequency in accordance with one or more aspects of the present disclosure.

FIG. 8 illustrates an example of a timeline that supports single DCI scheduling multiple uplink shared channels across time and frequency in accordance with one or more aspects of the present disclosure.

FIG. 9 illustrates an example of a process flow diagram that supports single DCI scheduling multiple uplink shared channels across time and frequency in accordance with one or more aspects of the present disclosure.

FIGS. 10 and 11 show block diagrams of devices that support single DCI scheduling multiple uplink shared channels across time and frequency in accordance with one or more aspects of the present disclosure.

FIG. 12 shows a block diagram of a communications manager that supports single DCI scheduling multiple uplink shared channels across time and frequency in accordance with one or more aspects of the present disclosure.

FIG. 13 shows a diagram of a system including a device that supports single DCI scheduling multiple uplink shared channels across time and frequency in accordance with one or more aspects of the present disclosure.

FIGS. 14 and 15 show block diagrams of devices that support single DCI scheduling multiple uplink shared channels across time and frequency in accordance with one or more aspects of the present disclosure.

FIG. 16 shows a block diagram of a communications manager that supports single DCI scheduling multiple uplink shared channels across time and frequency in accordance with one or more aspects of the present disclosure.

FIG. 17 shows a diagram of a system including a device that supports single DCI scheduling multiple uplink shared channels across time and frequency in accordance with one or more aspects of the present disclosure.

FIGS. 18 through 21 show flowcharts illustrating methods that support single DCI scheduling multiple uplink shared channels across time and frequency in accordance with one or more aspects of the present disclosure.

### DETAILED DESCRIPTION

Some wireless communications systems may support full duplex functionality for a user equipment (UE). In such examples, frequency and time resources may be allocated to support such functionality, resulting in subband frequency domain slots that include two or more disjointed downlink allocations, or two or more disjointed uplink allocations. The disjointed uplink or downlink allocations may be located disjointed bands, and may be separated by uplink or downlink bands, or guard bands. In some examples, a single downlink control information (DCI) may schedule a single transmission (e.g., on a physical downlink shared channel (PDSCH or PUSCH)) in a single slot (e.g., may schedule multiple transmissions across multiple slots, but no more than one transmission per slot). For a full duplex UE, if a network schedules PDSCH or PUSCH transmission in a single slot via multiple DCIs, then the UE may perform an increased number of blind decodes and receptions on PDCCHs, resulting in increased power expenditures, decreased battery life, increased delays, increased system latency, and increased signaling overhead.

Techniques described herein may support radio resource control (RRC) signaling and a single DCI that may schedule multiple transmissions (e.g., uplink, downlink, or both), in a single slot, and may schedule such sets of transmissions across multiple slots. For example, the described techniques provide for a single DCI that may schedule multiple transmissions (e.g., uplink, downlink, or both), in a single slot, and may schedule such sets of transmissions across multiple slots. For example, the network entity may configure the UE with both time domain resource allocation (TDRA) table and a frequency domain resource allocation (FDRA) table. Each row of the FDRA table may indicate one or multiple transmissions, and may indicate common parameters (e.g., a modulation and coding scheme (MCS)) for each subband in a given slot, or transmission specific parameters for each subband in a given slot, or both. In some examples, the DCI may include an FDRA and TDRA field. The TDRA field may indicate multiple slots, and the FDRA field may indicate multiple subbands. In some examples, the UE may interpret the FDRA and TDRA fields to indicate a single slot in which to transmit on multiple subbands, and the remaining indicated slots may include a single transmission per slot. In some other examples, the UE may interpret the FDRA and TDRA fields to indicate multiple subbands on which to communicate during each of the indicated slots.

The network entity may configure the UE with a threshold (e.g., a maximum) number of transmissions triggered by the DCI. The UE (e.g., and in some examples, the network entity) may drop one or more transmissions (e.g., uplink or downlink) that do not satisfy (e.g., exceed) the threshold. In some examples, the UE may drop scheduled transmissions in frequency first, then in time until the threshold is satisfied, or in time first, then in frequency, until the threshold is satisfied. In some other examples, the UE may drop the scheduled transmissions in order of time counting forward (e.g., from the DCI), or counting backward (e.g., from a reference point such as a next physical uplink control channel (PUCCH)).

Aspects of the disclosure are initially described in the context of wireless communications systems. Aspects of the disclosure are further illustrated by and described with reference to wireless communications systems, a slot duplexing diagram, time diagrams, and a process flow diagram. Aspects of the disclosure are further illustrated by and described with reference to apparatus diagrams, system diagrams, and flowcharts that relate to single DCI scheduling multiple uplink shared channels across time and frequency.

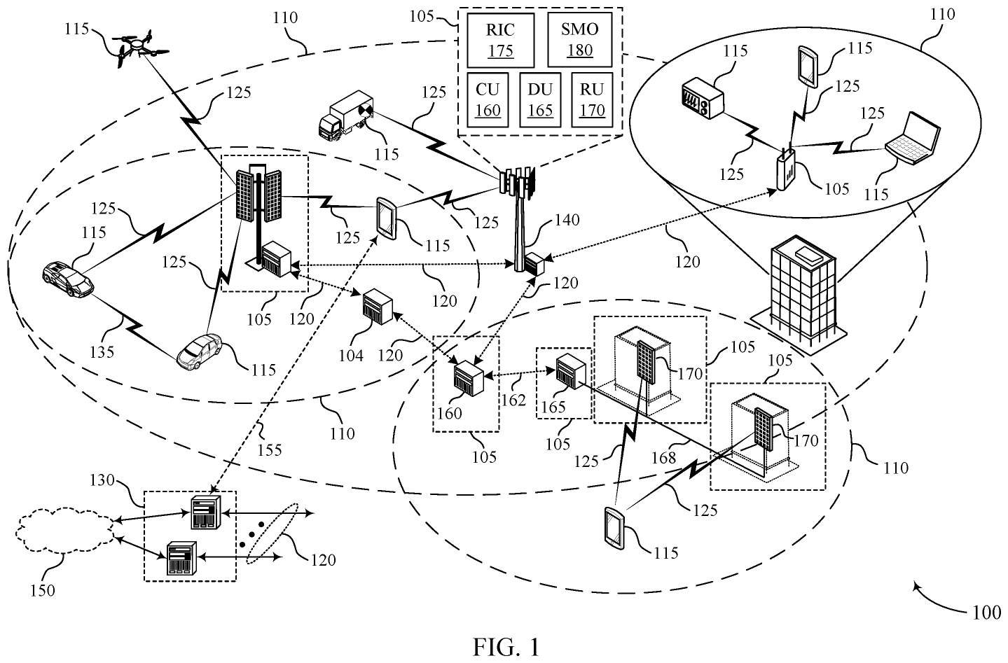

FIG. 1 illustrates an example of a wireless communications system 100 that supports single DCI scheduling multiple uplink shared channels across time and frequency in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., RRC, service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol). Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling via an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support single DCI scheduling multiple uplink shared channels across time and frequency as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, MC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

Techniques described herein may support RRC signaling and a single DCI that may schedule multiple transmissions (e.g., uplink, downlink, or both), in a single slot, and may schedule such sets of transmissions across multiple slots. For example, the network entity 105 may configure the UE 115 with both a TDRA table and an FDRA table. Each row of the FDRA table may indicate one or multiple transmissions, and may indicate common parameters (e.g., an MCS) for each subband in a given slot, or transmission specific parameters for each subband in a given slot, or both. In some examples, the DCI may include an FDRA and TDRA field. The TDRA field may indicate multiple slots, and the FDRA field may indicate multiple subbands. In some examples, the UE 115 may interpret the FDRA and TDRA fields to indicate a single slot in which to transmit on multiple subbands, and the remaining indicated slots may include a single transmission per slot. In some other examples, the UE may interpret the FDRA and TDRA fields to indicate multiple subbands on which to communicate during each of the indicated slots. The network entity 105 may configure the UE 115 with a threshold (e.g., a maximum) number of transmissions triggered by the DCI. The UE 115 (e.g., and in some examples, the network entity 105) may drop one or more transmissions (e.g., uplink or downlink) that do not satisfy (e.g., exceed) the threshold.

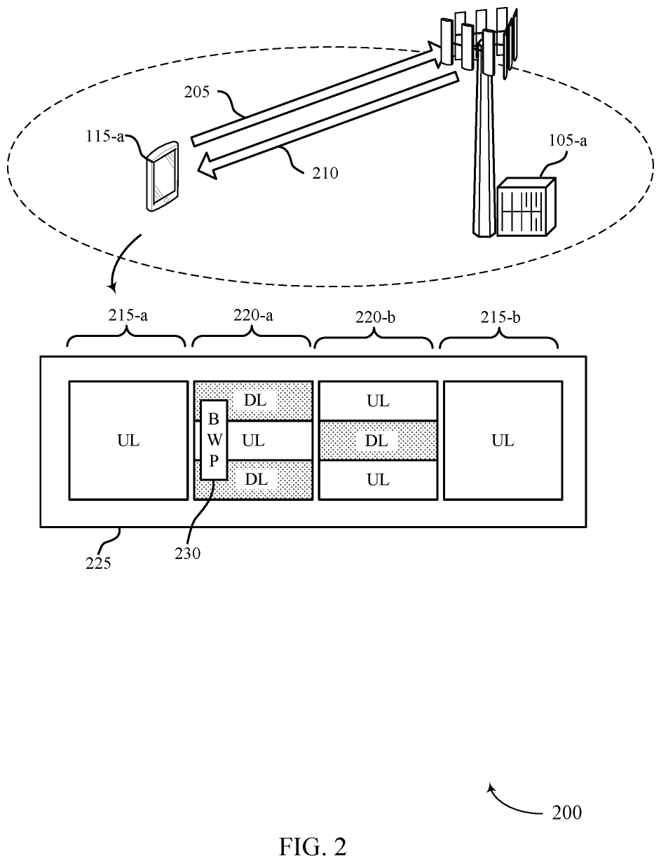

FIG. 2 illustrates an example of a wireless communications system 200 that supports single DCI scheduling multiple uplink shared channels across time and frequency in accordance with one or more aspects of the present disclosure. For example, wireless communications system 200 may support both half-duplex and full-duplex communications between devices such as a UE 115-a and a network entity 105-a.

While operating in a half-duplex mode, a wireless device such as a UE 115-a or network entity 105-a may transmit or receive uplink information during one time interval, and may transmit or receive downlink information during a different time interval. In some other examples, while operating in a full-duplex mode, the UE 115-a may transit uplink communications and receive downlink communications concurrently (e.g., at a same time and using a same time resource and different frequency resources). One example of such full-duplex operations may be in-band full-duplex (IBFD), which may allow transmitting and receiving terminals of the wireless device to transmit and receive simultaneously (e.g., at the same time and using the same time resource), and in the same frequency band. In such IBFD implementations, downlink and uplink communications may share the same IBFD time and frequency resource (e.g., the downlink and uplink resources may fully or partially overlap in time and frequency). Using IBFD, in some examples, may effectively increase (e.g., double) the spectrum utilization and throughout of the wireless system. A second example of full-duplex operations may be sub-band duplex communications (e.g., flexible duplex) where the wireless device may transmit and receive communications at the same time resource but on different frequency resources. In such examples, the downlink resource is separated from the uplink resource in the frequency domain via a guard band.

Some wireless networks may frequently switch between half-duplex configured slots (e.g., slot 215-a and slot 215-b) and full-duplex configured slots (e.g., slot 220-a and slot 220-b) of the resource allocation 225. For example, some full-duplex slots (e.g., slot 220-a and slot 220-b) may include multiple uplink and downlink sub-bands which may at least partially overlap with an allocated BWP 230 that is larger than the sub-band size. Various attributes of the BWP 230 are used in frequency domain resource assignment (FDRA) for communications using the full-duplex slot. For example, a first allocation type (e.g., allocation type 0) may be implemented for disjoint resource block allocation, where the network uses a bitmap (e.g., having 9 or 18 bits) to allocate a quantity of resource block groups (RBGs) for uplink or downlink communications within the full-duplex slot. In accordance with the resource allocation type 0, the RBG size allocated for communications is based on BWP size and the configuration type (e.g., RBG-Size; ENUMERATED {config1, config2}. For example, the RBG size P may be selected from a table such as table 1, shown below:

TABLE 1
Nominal RBG Size P

| BWP Size | Configuration 1 | Configuration 2 |
|---|---|---|
| 1-36 | 2 | 4 |
| 37-72 | 4 | 8 |
| 73-144 | 8 | 16 |
| 145-275 | 16 | 16 |

In some other examples, a second resource allocation type (e.g., allocation type 1) may be implemented to allocate a quantity of consecutive resource blocks for communications. Such resource allocations may be indicated by a first available resource block present in the BWP (e.g., RB_start) and the quantity of consecutive resource blocks that are combined in the resource indicator value (MV) field. To determine the MV, for example, a device may use the length of the allocated resource blocks (L_{RBs}), the size of the BWP (N_{BWP}^{size}), and the starting resource block (RBₛₜₐᵣₜ), such that:

if (L_{RBs}−1)≤└N_{BWP}^{size}/2┘,then

RIV=N_{BWP}^{size}(L_{RBs}−1)+RBₛₜₐᵣₜ, else

RIV=N_{BWP}^{size}(N_{BWP}^{size}−L_{RBs}+1)+(N_{BWP}^{size}−1−RBₛₜₐᵣₜ).

In some examples, the RIV may include a start and length indicator value (SLIV) for consecutive resource allocation. The SLIV used for resource allocation may rely on the starting resource block of a physical resource block (PRB), but the starting resource block may not be available because it overlaps with the one or more sub-bands of the full-duplex slot. Further, if there is repetition between two different slot types (e.g., half-duplex and full-duplex), the first resource block may be counted differently to avoid falling in another sub-band not meant for transmission.

Additionally, or alternatively, in cases that the BWP 230 at least partially overlaps with multiple sub-bands, not all of the resources in the BWP may be available for resource allocation (e.g., if allocating resources for uplink communications, the portions of the BWP that overlap with a downlink sub-band within the slot may not be available for use, and vice versa). Also, with the change in duplexity of the slots (e.g., from half-duplex to full-duplex), changing the BWP size to increase the quantity of available resources may not be practical or efficient (e.g., due to increased signaling for indicating a BWP change).

In some examples, the network entity 105-a may transmit a DCI that triggers multiple transmissions across multiple slots 215, multiple slots 220, or both, or across multiple bands, subbands, or BWPs 230, or any combination thereof, as described in greater detail herein.

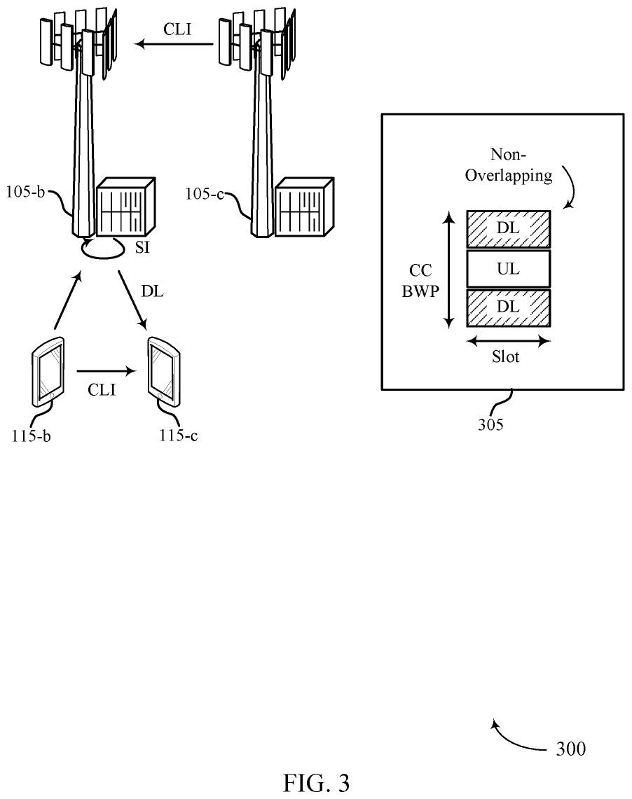

FIG. 3 illustrates an example of a wireless communications system 300 that supports single DCI scheduling multiple uplink shared channels across time and frequency in accordance with one or more aspects of the present disclosure. For example, wireless communications system 300 may support full-duplex communications at network entity 105-b, and half-duplex communications at UEs 115-b and 115-c. For example, the network entity 105-b or 105-c may support or otherwise be configured to receive or otherwise obtain an uplink (UL) transmission from UE 115-b or UE 115-c, and at the same time, perform a downlink (DL) transmission the UE 115-b, the UE 115-c, or both. In some examples, the network entity 105-b may perform a downlink transmission to UE 115-b, which may be a neighboring UE with respect to UE 115-c (e.g., at the same time or at a different time as performing the downlink transmission to UE 115-c).

In some examples, the full-duplex communications may include sub-band full-duplex (SBFD) (also referred to as “flexible duplex”) where the same time resources (e.g., within a slot) are used, but different frequency resources (e.g., within the BWP (BW) of a CC) are used for the communications. For example, the downlink and uplink communications may share the same time resources (e.g., the communications may be performed at the same time, at least to some degree), and the uplink communications may use different frequency resources than the downlink communications. One example of such SBFD may include non-overlapping configuration 305 where the uplink and downlink communications are performed at the same time, but using different frequency resources. In some aspects, the downlink resources (e.g., the frequency resources used for the downlink communications) may be separated from the uplink resources (e.g., the frequency resources used for the uplink communications) in the frequency domain (e.g., there may be a frequency gap between uplink frequency resources and downlink frequency resources). In some examples, the UEs 115-b and 115-c may experience cross-link interference (CLI) with one another, and the network entities 105-b and 105-c may also experience CLI with one another. Additionally, or alternatively, the full-duplex network entity 105-b may experience self-interference (SI) based on the uplink and downlink signaling performed simultaneously.

In some examples, the network entity 105-b may allocate a quantity of resources based on information associated with a configured BWP that may be associated with the full-duplex slot. For example, using FDRA, the network may support disjoint resource block allocation, or consecutive resource block allocation

In some examples, the network entity 105-a may transmit a DCI that triggers multiple transmissions across multiple slots 215, multiple slots 220, or both, or across multiple bands, subbands, or BWPs 230, or any combination thereof, as described in greater detail herein.

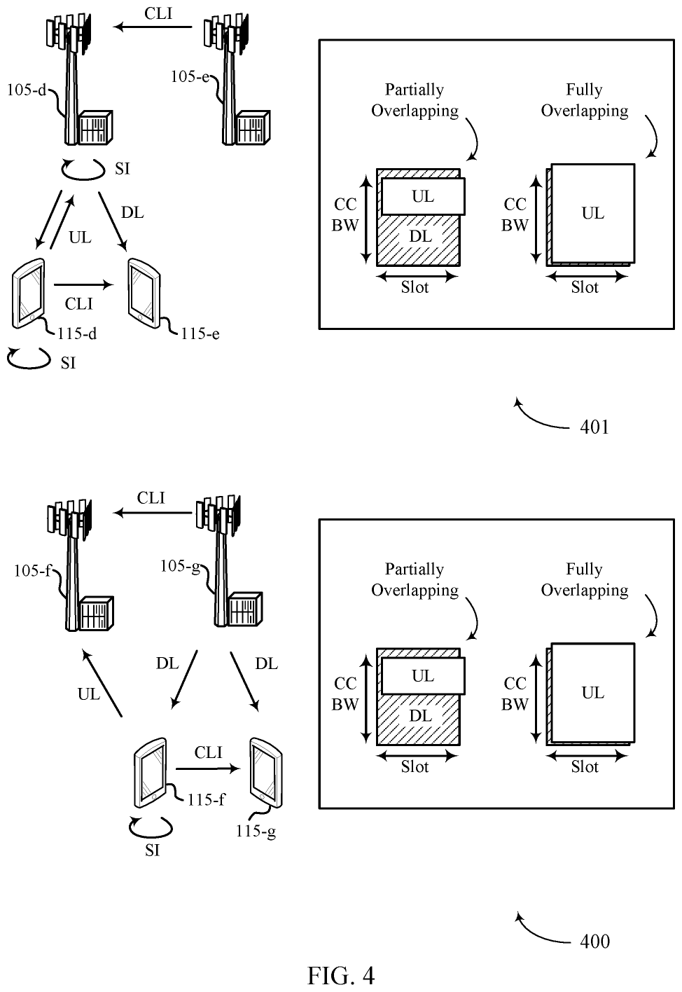

FIG. 4 illustrates an example of wireless communications systems 400 and 401 that support single DCI scheduling multiple uplink shared channels across time and frequency in accordance with one or more aspects of the present disclosure. For example, wireless communications system 400 may support full-duplex communications at network entities 105-d and 105-e, as well as at UE 115-d, and half-duplex communications at UE 115-e. For example, the network entity 105-d or 105-e may support or otherwise be configured to receive or otherwise obtain an uplink (UL) transmission from UE 115-d or UE 115-e, and at the same time, perform a downlink (DL) transmission the UE 115-d, the UE 115-e, or both. In some examples, the network entity 105-d may perform a downlink transmission to UE 115-d, which may be a neighboring UE with respect to UE 115-e (e.g., at the same time or at a different time as performing the downlink transmission to UE 115-e).

Wireless communications system 401 may support full-duplex communications at network entities 105-f and 105-g, as well as at UEs 115-f and 115-g. In some examples, the network entities 105-f and 105-g may be full-duplex-capable network entities, and UEs 115-f and 115-g may be SBFD-capable UEs. For example, the network entity 105-f or 105-g may support or otherwise be configured to receive or otherwise obtain an uplink (UL) transmission from UE 115-f or UE 115-g, and at the same time, perform a downlink (DL) transmission the UE 115-f, the UE 115-g, or both. In some examples, the network entity 105-g may perform downlink transmissions to UEs 115-f and 115-g, while the UE 115-f transmits an uplink message to the network entity 105-f.

A slot format may generally be defined as a downlink-plus-uplink slot in which the band (e.g., frequency resources) is used for both uplink and downlink communications. The downlink and uplink communications may occur in overlapping bands (e.g., IBFD) or in adjacent bands (e.g., SBFD). In a given symbol of a downlink-plus-uplink slot, a UE supporting half-duplex communications may either perform an uplink transmission in the uplink frequency resources or receive a downlink transmission in the downlink frequency resources. In a given symbol of a downlink-plus-uplink slot, a UE supporting full-duplex communications may both perform an uplink transmission in the uplink frequency resources and/or receive a downlink transmission in the downlink frequency resources. A given downlink-plus-uplink slot may include downlink-only symbols, uplink-only symbols, or full-duplex symbols.

However, communications within any wireless communication system are generally associated with introducing interference into the network. That is, any device within wireless communications systems 400 and 401 performing a transmission introduces at least some degree of interference into the network (e.g., interference that may then impact and/or must then be mitigated by other devices within the network). Two non-limiting examples of such interference include CLI and SI.

CLI is broadly defined as interference caused by or otherwise introduced into the network by another device performing a wireless transmission. For example, inter-cell interference may be caused by or otherwise associated with CLI caused by other network entities. For example, network entity 105-d may introduce inter-cell interference from the perspective of network entity 105-e when network entity 105-d performs the downlink transmissions to UE 115-d and/or UE 115-e. Intra-cell CLI may generally be associated with interference from UEs within the same cell where inter-cell CLI may generally be associated with interference from UEs in adjacent cells. For example, UE 115-d may introduce CLI (e.g., intra-cell or inter-cell CLI) into the network from the perspective UE 115-e when performing the uplink transmission to network entity 105-d.

SI is broadly defined as interference caused to a device by that device performing full-duplex communications. That is, a device (such as UE 115-d) configured to or otherwise supporting performing full-duplex communications may include separate transmit and receive chains (including antenna(s)) enabling the device to perform a transmission while also receiving a different transmission. The transmission being performed introduces SI into the receive chain (e.g., including antenna(s)) being used to receive the transmission.

In some examples, the network entity 105-a may transmit a DCI that triggers multiple transmissions across multiple slots 215, multiple slots 220, or both, or across multiple bands, subbands, or BWPs 230, or any combination thereof, as described in greater detail herein.

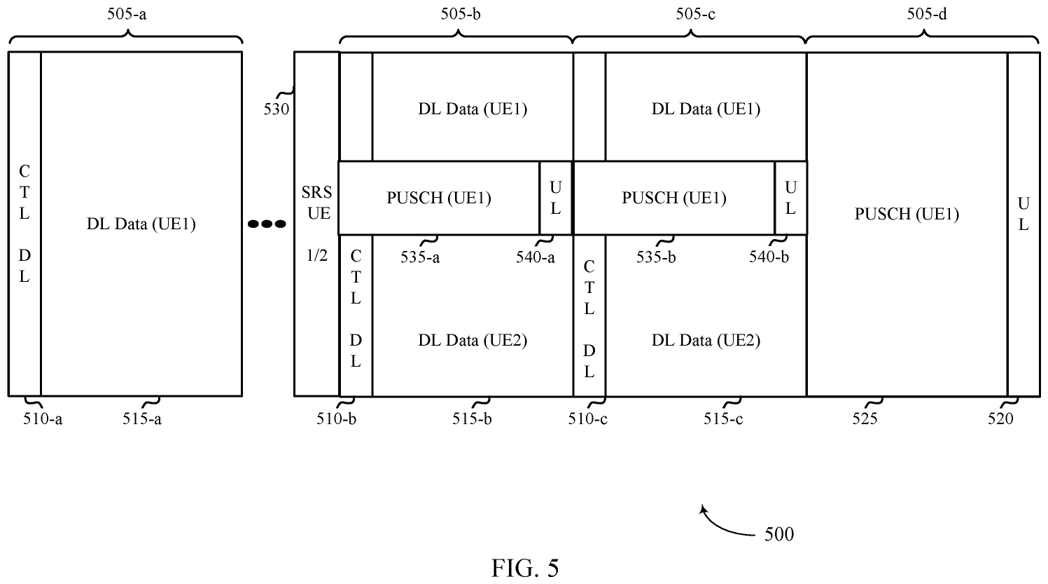

FIG. 5 illustrates an example of a slot duplexing configuration 500 that supports single DCI scheduling multiple uplink shared channels across time and frequency in accordance with one or more aspects of the present disclosure. Slot duplexing configuration 500 illustrates an example of duplexing operations that may be adopted in accordance with the techniques described herein. For example, a plurality of slots 505 may be available for communications between a UE and a network entity as described with reference to FIGS. 1-4. In some examples, the slot duplexing configuration 500 may be used to support the techniques for determining the first available resource block and the effective BWP size as described herein.

Each slot 505 may generally include a control (CTL) portion (e.g., a physical downlink control channel (PDCCH) used for communicating control information, such as DCI communications) and a data portion (e.g., a PDSCH used for communicating data). Slot 505-a provides an example of a downlink slot where the control portion 510-a comprises a downlink control portion (e.g., PDCCH) and data portion 515-a comprises a downlink data portion (e.g., PDSCH). For downlink slots 505, the control portion occurs at the beginning of the slot 505 (e.g., the first two or three symbols) while the data portion 515-a uses most or all of the remaining symbols in the slot (there may be one or more gap symbols within the data portion 515). Slot 505-d comprises an example of an uplink slot where the control portion 520 occurs in the last two or three symbols of the slot 505 and the data portion 525 occurs in the remaining symbols of the slot 505. Moreover, some slots 505 may include one or more portions 530 where UE (such as a first UE, UE1, and a second UE, UE2) perform sounding reference signal (SRS) transmissions to sound the channel.

In some examples, slot 505-b and slot 505-c illustrate examples of flexible duplexing (e.g., downlink-plus-uplink) slots. In particular, slot 505-b and slot 505-c illustrate examples of SBFD slots supporting full-duplex communications using uplink resources (e.g., PUSCH) as well as using downlink resources (e.g., PDSCH). For example, the time resources may overlap in the time domain in the SBFD scenario while the frequency resources used for downlink transmissions are different from the frequency resources used for uplink transmissions. In some examples, the downlink and uplink transmissions may occur in overlapping bands (e.g., IBFD) or adjacent bands (e.g., SBFD). In a given downlink-plus-uplink symbol, a UE configured for half-duplex communications may either transmit communications in the uplink band or receive in the downlink band. Additionally, or alternatively, a UE configured for full-duplex communications may transmit in the uplink band and/or receive in the downlink band in the same slot. In some cases, a downlink-plus-uplink slot may include downlink symbols, uplink symbols, or full-duplex symbols.

In some examples, slot 505-b including a first portion of downlink frequency resources allocated to downlink transmissions to the first UE (e.g., PDSCH for UE1) and a second portion of downlink frequency resources allocated to downlink transmissions to the second UE (e.g., PDSCH for UE2). Slot 505-b may include control portion 510-b and data portion 515-b. Slot 505-b may also include a set of uplink frequency resources, that may optionally include both a data portion 535-a (e.g., used for communicating uplink data) and a control portion 540-a (e.g., used for communicating scheduling requests (SR) transmissions, buffer status report (BSR) transmissions, uplink control information (UCI) transmissions, etc.).

In some other examples, the slot 505-c including a first portion of downlink frequency resources allocated to downlink transmissions to the first UE (e.g., PDSCH for UE1) and a second portion of downlink frequency resources allocated to downlink transmissions to the second UE (e.g., PDSCH for UE2). Slot 505-c may include a control portion 510-c and a data portion 515-c. Slot 505-c may also include a set of uplink frequency resources, that may optionally include both a data portion 535-b and a control portion 540-b.

Techniques described herein support DCI signaling that schedules multiple transmissions (e.g., uplink, downlink, or both), in a single slot, and may schedule such sets of transmissions across multiple slots. For example, the network may configure the UE with both a TDRA table and an FDRA table. Each row of the FDRA table may indicate one or multiple transmissions, and may indicate common parameters (e.g., an MCS) for each subband in a given slot, or transmission specific parameters for each subband in a given slot, or both. A DCI may include an FDRA and TDRA field. The TDRA field may indicate multiple slots, and the FDRA field may indicate multiple subbands. The UE may interpret the FDRA and TDRA fields to indicate a single slot in which to transmit on multiple subbands, and the remaining indicated slots may include a single transmission per slot. Additionally, or alternatively, the UE may interpret the FDRA and TDRA fields to indicate multiple subbands on which to communicate during each of the indicated slots. In some examples, the network may configure the UE with a threshold number of transmissions triggered by the DCI. The UE (e.g., and the network) may drop one or more transmissions (e.g., uplink transmissions or downlink transmissions) that exceed the threshold. The UE may drop scheduled transmissions in frequency first, then in time until the threshold is reached, or in time first, then in frequency, until the threshold is reached. The UE may drop the scheduled transmissions in order of time counting forward (e.g., from the DCI), or counting backward (e.g., from a reference point such as a next PUCCH).

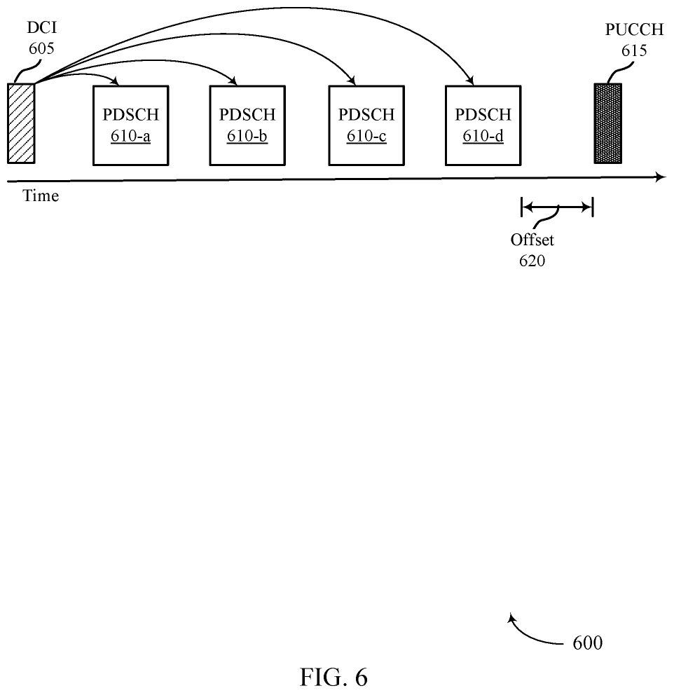

FIG. 6 illustrates an example of a timeline 600 that supports single DCI scheduling multiple uplink shared channels across time and frequency in accordance with one or more aspects of the present disclosure. Timeline 600 may implement, or be implemented by, aspects of wireless communications systems 100, 200, 300, 400, and 401, as well as slot duplexing configuration 500. For example, a UE and a network entity, which may be examples of corresponding devices described with reference to FIGS. 1-5 (e.g., a network entity 105 and a UE 115), may communicate with each other according to timeline 600. Although illustrated with reference to PDSCHs 610, the techniques described with reference to FIG. 5 may similarly be applied to other channels (e.g., PUSCHs).

In some examples, a number of transmissions on a shared channel (e.g., a PDSCH or a PUSCH) scheduled by a single DCI 605 may be based on a number of time domain resource allocated to the UE in a corresponding row of a TDRA table. For example, an RRC configuration message may configure the UE with a TDRA table, and the DCI 605 may indicate (e.g., in a TDRA field) a row index associated with the RRC configured TDRA table. The indicated row may define a number of configuration of transmissions across time resources (e.g., may indicate one or multiple PDSCHs 610). Each row of the TDRA table may include one or more multiple combinations of transmission configurations (e.g., may indicate a mapping type, scheduling offset (e.g., K0 or K2), a starting symbol, a number of consecutive symbols, among other examples) for one or more PDSCH 610 scheduled by the DCI 605.

For example, the DCI 605 may include a TDRA field which may be a row index for the TDRA table. The indicated row of the TDRA table may include configuration information for each of PDSCH 610-a, PDSCH 610-b, PDSCH 610-c, and PDSCH 610-d. For instance, the row may include a K0 or K2 value (e.g., a slot offset between a downlink slot in which the DCI 605 is received by the UE and the slot where the PDSCH 610 is scheduled), a start symbol and number of consecutive symbols together, which may be referred to as a start and length indicator value (SLIV), or a combination thereof, for each PDSCH 610. There may be a single combination of such parameter values for scheduling a single PDSCH or PUSCH, or multiple combinations for a parameter of feature that one DCI 605 can schedule multiple PDSCHs or PUSCHs.

The network may configure the TDRA table with sufficient combinations to provide good scheduling flexibility (e.g., in the time domain). A row of the TDRA table may indicate PDSCHs or PUSCHs in consecutive or non-consecutive slots. Some fields or parameters may be common to all scheduled PUSCH or PDSCHs indicated by the DCI 605 (e.g., such that the DCI size does not result in excessive signaling overhead). For instance, the DCI 605 may indicate, via the TDRA field, a row of the TDRA table. The row of the TDRA table may indicate a PDSCH mapping type (e.g., Type A), a K0 value (e.g., 0), a starting symbol (e.g., 2), and a length (e.g., 6). In some examples, offset 620 (e.g., K1) may indicate an amount of time for a PDSCH or PUSCH (e.g., a final or last PDSCH 610-d) to a subsequent channel (e.g., PUCCH 615) or slot.

A single DCI 605 schedules a single uplink or downlink transmission (e.g., a single uplink transmission on a PUSCH or a single downlink transmission on a PDSCH) in one slot (e.g., although the DCI 605 may schedule multiple PDSCHs 610 across multiple slots, the DCI 605 may not be able to schedule multiple PDSCHs 610 in a single slot).

In some examples, SBFD slots may have two disjoint downlink allocations, or two disjoint uplink allocations, or both (e.g., as described in greater detail with reference to FIG. 5). In such examples, the two uplink or downlink disjointed bands may be separated by an uplink or downlink band, in addition to any guard bands. The UE may be capable of performing uplink transmissions, downlink transmissions, or both, across various subbands (e.g., in a single slot for full duplex UEs, or across multiple slots for half duplex UEs). However, if a DCI can schedule multiple transmission in time in a single band or subband (e.g., but cannot schedule multiple transmissions across multiple bands or subbands), then the network may provide multiple DCIs (e.g., one DCI for each subband). This may result in increased signaling overhead, inefficient use of available resources, an increase in blind decoding procedures performed by the UE, increased power expenditures, decreased battery life for the UE, and decreased user experience, among other examples.

Techniques described herein may support a single DCI 605 scheduling multiple transmissions (e.g., PDSCH or PUSCH) across multiple subbands (e.g., in a same slot). For half duplex UEs, the DCI 605 may schedule multiple PDSCHs or multiple PUSCHs (e.g., but not both). For a full duplex UE, the single DCI 605 may schedule PUSCHs, PDSCHs, or both, in a same slot in two different subbands (e.g., uplink and downlink subbands, respectively). Such techniques may reduce a number of DCIs that the UE decodes to schedule multiple transmissions (e.g., multiple PUSCHs or multiple PUCCHs).

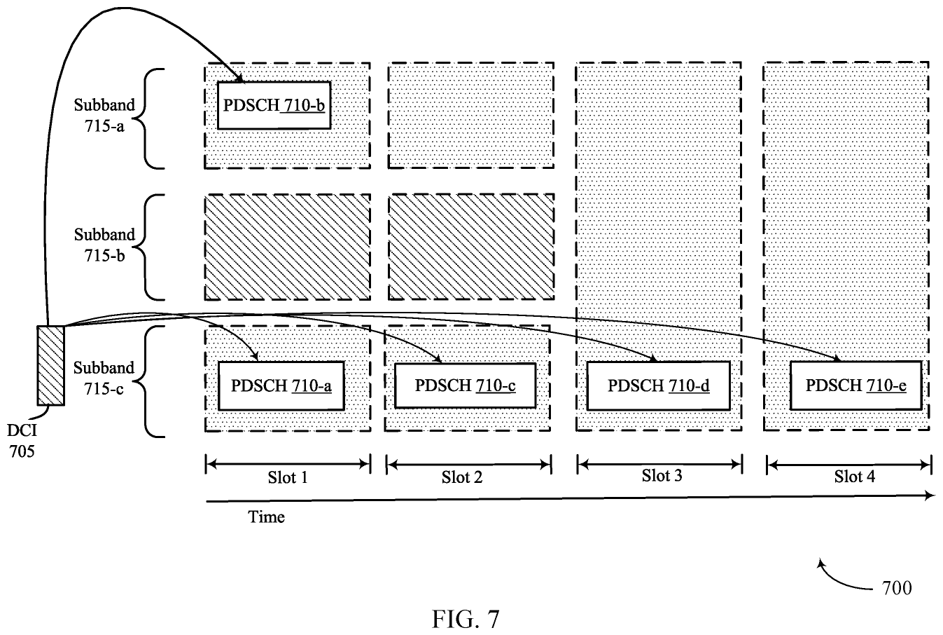

In some examples described herein (e.g., with reference to FIGS. 7-10), the network may configure an FDRA table (e.g., and the TDRA table). The network may then indicate (e.g., via the FDRA field of a DCI message) multiple transmissions across multiple sub-bands (e.g., within one or more slots). The FDRA field in the scheduling DCI may point to an RRC configured table (e.g., the FDRA table), where each row of the table indicates possible multiple transmissions on different sub-bands. Any given row of the table may indicate a single transmission (e.g., on a single subband), or multiple transmissions (e.g., on multiple subbands). If a row indicates multiple transmissions, the row may include configuration parameters for the FDRA for each scheduled PDSCH or PUSCH. For instance, a row of the table may include an indication of a PDSCH mapping type (e.g., Type 0) in a first column, a bitmap (e.g., in a second column). The bitmap may indicate one or more subbands for the one or multiple scheduled transmissions (e.g., each bit of the bitmap may indicate a first RB of a respective subband). The multiple transmission scheduled across various frequency bands or subbands may have common parameters, dedicated parameters, or both. For instance each PDSCH or PUSCH may have a same FDRA interpreted with a reference starting point (e.g., a single reference point from which each PDSCH or PUSCH is defined). Some parameters for the multiple PUSCHs or PDSCHs may be common. For instance, a location for each PDSCH or PUSCH may be different, but an MCS may be common for all PDSCHs or PUSCHs scheduled by the single DCI.

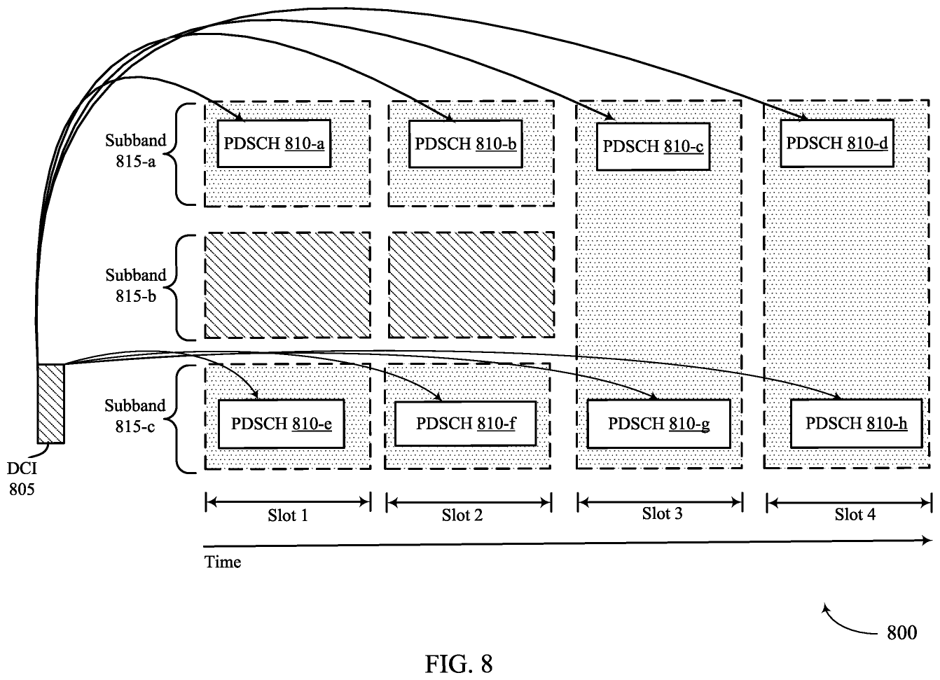

The UE may receive the DCI, including the FDRA and the TDRA which indicate rows from the FDRA table and the TDRA table, respectively. The UE may interpret the FDRA and TDRA of the DCI according to one or more rules, as described in greater detail with reference to FIG. 7 and FIG. 8.

FIG. 7 illustrates an example of a timeline 700 that supports single DCI scheduling multiple uplink shared channels across time and frequency in accordance with one or more aspects of the present disclosure. Timeline 700 may implement, or be implemented by, aspects of wireless communications systems 100, 200, 300, 400, and 401, as well as slot duplexing configuration 500 and timeline 600. For example, a UE and a network entity, which may be examples of corresponding devices described with reference to FIGS. 1-6 (e.g., a network entity 105 and a UE 115), may communicate with each other according to timeline 700. Although illustrated with reference to PDSCHs 710, the techniques described with reference to FIG. 7 may similarly be applied to other channels (e.g., PUSCHs). For instance, a DCI 705 may schedule multiple uplink transmissions (e.g., on multiple PUSCHs), or multiple downlink transmissions (e.g., on multiple PDSCHs 710), or both, during a single time interval (e.g., a single slot) or multiple time intervals (e.g., multiple slots). The UE may be a half-duplex UE or a full duplex UE.

The UE may communicate according to timeline 700, and the UE may be able to communicate via one or more sets of frequency resources. Although illustrated and described with reference to subbands 715, techniques described herein (e.g., with reference to FIGS. 7-10) may be performed via any set of frequency resources (e.g., BWP, band, subband, among other examples). For example, slot 1 and slot 2 may be downlink slots for a half-duplex UE (e.g., the UE may receive downlink signaling via subband 715-c and subband 715-a). Or, in some examples, slot 1 and slot 2 may be downlink-plus-uplink slots (e.g., the UE may receive downlink signaling via subband 715-c and subband 715-a, and may transmit uplink signaling via subband 715-b), and slot 3 and slot 4 may be downlink slots (e.g., across subband 715-a, subband 715-b, and subband 715-c).

In some examples, the network entity may configure the UE with a TDRA table and an FDRA table, as described in greater detail with reference to FIG. 6. The DCI 705 may include a TDRA field and an FDRA field, which both may indicate multiple transmissions. The UE may assume multiple transmissions across time and frequency (e.g., according to one or more rules). For example, the UE may assume multiple transmissions (e.g., multiple downlink transmissions via PDSCHs 710) across indicated subbands 715 in a single indicated slot (e.g., slot 1), and may assume multiple transmissions (e.g., multiple downlink transmissions via PDSCHs 710) across slots as indicated via the TDRA field.

For instance, the TDRA field in the DCI 705 may index a row of the TDRA field indicating three transmissions (e.g., in slot 2, slot 3, and slot 4), and the FDRA field in the DCI 705 may index a row of the FDRA field indicating two transmissions (e.g., in a single indicated slot, such as slot 1). In such examples, the UE may interpret the FDRA and the TDRA fields to indicate two transmissions in slot 1 (e.g., as indicated by the FDRA field), and across four slots (e.g., the slot 1, the slot 2, the slot 3, and the slot 4. The UE may interpret the FDRA as indicating the PDSCH 710-a on the subband 715-c and the PDSCH 710-b on the subband 715-a. The UE may also interpret the TDRA as indicating the PDSCH 710-c during slot 2, the PDSCH 710-d during the slot 3, and the PDSCH 710-e (e.g., the TDRA field may indicate the additional slots in which only a single PDSCH 710 is located). Thus, the UE may interpret the FDRA field (e.g., which indicates two PDSCHs) as applying to a single slot, and may interpret the slots indicated in the TDRA field as indicating a slot that includes a single PDSCH 710.

In some examples, the UE may determine which slot to which the multiple subbands 715 indicated in the FDRA field apply based on a rule (e.g., included in one or more standards, or preconfigured at the UE). In some examples, the UE may determine which slot to which the multiple subbands 715 indicated in the FDRA field apply based on an indication from the network device. For example, the FDRA field may indicate a set of slots, a first subband 715-c in which PDSCHs 710 are to be transmitted via each of the set of slots, and may further indicate to which slot the multiple subbands (e.g., the second subband 715-a) are to be applied. Such information may be included in a row of the FDRA table indicated by the FDRA field. In some examples, such information may be indicated in the TDRA field (e.g., the TDRA field may indicate the set of slots, and which of the set of slots corresponds to multiple PDSCHs 710. Described techniques may be similarly be applied for scheduling of any channels (e.g., PDSCHs, PUSCHs, or both). Techniques described with reference to FIG. 7 may be performed in various slot types (e.g., full duplex slots, half duplex slots, etc.). That is, the FDRA and TDRA fields of the DCI 705 may indicate uplink transmissions, downlink transmissions, or both within a single slot, or across multiple slots (e.g., an uplink transmission and a downlink transmission in a single slot for full duplex slots, and either uplink transmissions or downlink transmissions in a half-duplex slot or a full duplex slot).

In some examples, as described in greater detail with reference to FIG. 8, the UE may interpret the FDRA field and the TDRA field as indicating multiple transmissions in multiple slots.

FIG. 8 illustrates an example of a timeline 800 that supports single DCI scheduling multiple uplink shared channels across time and frequency in accordance with one or more aspects of the present disclosure. Timeline 700 may implement, or be implemented by, aspects of wireless communications systems 100, 200, 300, 400, and 401, as well as slot duplexing configuration 500, timeline 600, and timeline 700. For example, a UE and a network entity, which may be examples of corresponding devices described with reference to FIGS. 1-7 (e.g., a network entity 105 and a UE 115), may communicate with each other according to timeline 800. Although illustrated with reference to PDSCHs 810, the techniques described with reference to FIG. 8 may similarly be applied to other channels (e.g., PUSCHs). For instance, a DCI 805 may schedule multiple uplink transmissions (e.g., on multiple PUSCHs), or multiple downlink transmissions (e.g., on multiple PDSCHs 810), or both, during a single time interval (e.g., a single slot) or multiple time intervals (e.g., multiple slots). The UE may be a half-duplex UE or a full duplex UE.

The UE may communicate according to timeline 800, and the UE may be able to communicate via one or more sets of frequency resources. Although illustrated and described with reference to subbands 715, techniques described herein (e.g., with reference to FIGS. 7-10) may be performed via any set of frequency resources (e.g., BWP, band, subband, among other examples). For example, slot 1 and slot 2 may be downlink slots for a half-duplex UE (e.g., the UE may receive downlink signaling via subband 815-c and subband 815-a). Or, in some examples, slot 1 and slot 2 may be downlink-plus-uplink slots (e.g., the UE may receive downlink signaling via subband 815-c and subband 815-a, and may transmit uplink signaling via subband 815-b), and slot 3 and slot 4 may be downlink slots (e.g., across subband 815-a, subband 815-b, and subband 815-c).

In some examples, the network entity may configure the UE with a TDRA table and an FDRA table, as described in greater detail with reference to FIG. 6. The DCI 805 may include a TDRA field and an FDRA field, which both may indicate multiple transmissions. The UE may assume multiple transmissions across time and frequency (e.g., according to one or more rules). The UE may assume that the DCI schedules multiple transmissions (e.g., PDSCH or PUSCH transmissions) across indicated subbands 815 in each of the indicated slots. For instance, the FDRA field may indicate (e.g., by indexing a row of the FDRA table) two subbands (e.g., the subband 815-a and the subband 815-c). The TDRA field may indicate (e.g., by indexing a row of the TDRA table) four slots (e.g., slot 1, slot 2, slot 3, and slot 4). The relationship between transmissions in a same slot may be given by the FDRA field, and may be fixed across all slots. For instance, the FDRA field may indicate (e.g., by indexing a row of the FDRA table) one or more parameters (e.g., such as frequency resources, offsets, or the like) indicating frequency resources in the subband 815-a, and the subband 815-c. The TDRA field may indicate (e.g., by indexing a row of the FDRA table) one or more parameters (e.g., starting symbol, offset values, length, etc.) indicating a set of slots (e.g., slot 1, slot 2, slot 3, and slot 4). The UE may determine, based on the FDRA field, the TDRA field, one or more rules, or a combination thereof, that the DCI 805 schedules transmissions in the multiple indicated subbands 815 via each of the indicated slots. For instance, the DCI 805 may schedule the PDSCH 810-a and the PDSCH 810-e during slot 1, the PDSCH 810-b and the PDSCH 810-f during slot 2, the PDSCH 810-c and the PDSCH 810-g during slot 3, and the PDSCH 810-d and the PDSCH 810-h during slot 4.

In some examples, the UE may perform joint interpretation of multiple transmissions across time and frequency, but may drop on or more scheduled transmissions to conform to a threshold number of transmissions. For example, the network entity may configure the UE with a threshold (e.g., maximum) quantity of transmissions (e.g., PDSCH transmissions or PUSCH transmissions). For instance, the network may indicate the threshold quantity of transmissions via control signaling (e.g., higher layer signaling such as RRC signaling). If an indicated number of grants is less than or equal to the threshold quantity of transmissions, then the UE may perform the scheduled transmissions. For instance, if the threshold quantity of transmissions is eight, and the DCI 805 indicates two subbands and four slots in which PDSCHs 810 are scheduled, then the UE may monitor for and receive downlink signaling via PDSCH 810-a, PDSCH 810-b, PDSCH 810-c, PDSCH 810-d, PDSCH 810-e, PDSCH 810-f, PDSCH 810-g, and PDSCH 810-h.

If the indicated quantity of transmissions (e.g., grants) does not satisfy the threshold quantity of transmissions (e.g., is greater than the threshold), then the UE may drop one or more transmissions (e.g., may refrain from monitoring for one or more scheduled downlink transmissions or may refrain from sending one or more scheduled uplink transmissions). For instance, of the threshold quantity of transmissions is five, then the UE may drop three of the scheduled PDSCHs.

In some examples, the UE may drop scheduled transmissions according to a prioritization scheme or in a particular order. For instance, the UE may drop transmissions in frequency first, and then in time, until the threshold quantity of transmissions is reached. If the UE drops transmissions in time frequency, then in time (e.g., working backwards in time from a reference point, such as a subsequent PUCCH or a last slot of the indicated set of slots), the UE may first drop PDSCH 810-d and PDSCH 810-h (e.g., all available subbands 815 in the first considered slot 4), and may then drop transmissions in a first subband 815-a (e.g., the PDSCH 810-c) in the next considered slot 3. Similarly, the UE may work forward in time from the DCI 805, in which case the UE may drop the PDSCH 810-a and the PDSCH 810-e in the first considered slot 1, and may also drop the PDSCH 810-b in the next considered slot 2.

In some examples, the UE may drop transmissions in time first, and then in frequency, until the threshold quantity of transmission is reached. If the UE drops the transmissions in frequency first, then in time (e.g., working backwards in time from a reference point, such as a subsequent PUCCH or a last slot of the indicated set of slots), the UE may first drop the PDSCH 810-d in slot 4, the PDSCH 810-c in slot 3, and the PDSCH 810-b in slot 2. Similarly, the UE may work forward in time from the DCI 805, in which case the UE may drop the PDSCH 810-a in slot 1, the PDSCH 810-b, and the PDSCH 810-c.

Described techniques may be similarly applied for scheduling of any channels (e.g., PDSCHs, PUSCHs, or both). Techniques described with reference to FIG. 8 may be performed in various slot types (e.g., full duplex slots, half duplex slots, etc.). That is, the FDRA and TDRA fields of the DCI 805 may indicate uplink transmissions, downlink transmissions, or both within a single slot, or across multiple slots (e.g., an uplink transmission and a downlink transmission in a single slot for full duplex slots, and either uplink transmissions or downlink transmissions in a half-duplex slot or a full duplex slot).

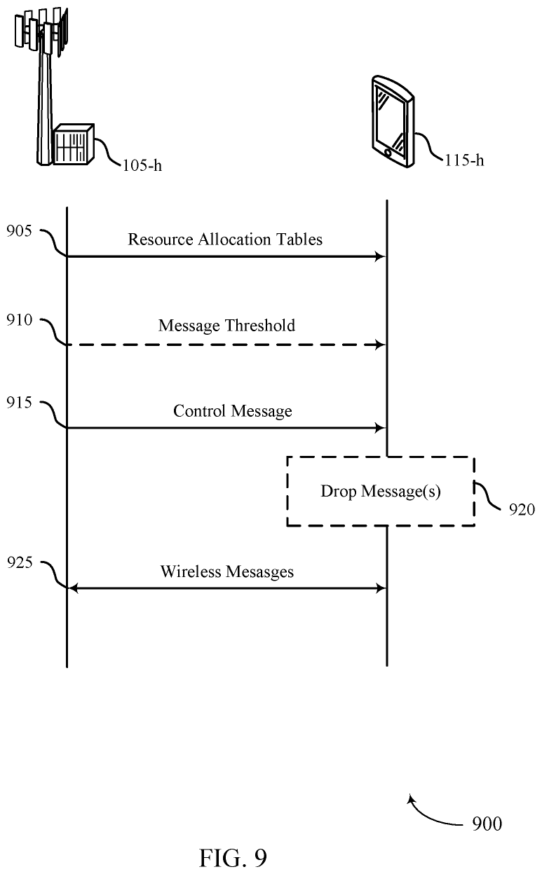

FIG. 9 illustrates an example of a process flow diagram 900 that supports single DCI scheduling multiple uplink shared channels across time and frequency in accordance with one or more aspects of the present disclosure. Process flow diagram 900 may implement, or be implemented by, aspects of wireless communications systems 100, 200, 300, 400, and 401, as well as slot duplexing configuration 500, and timelines 600, 700, and 800. For example, a UE 115-h and a network entity 105-h, which may be examples of corresponding devices described with reference to FIGS. 1-8 (e.g., a network entity 105 and a UE 115), may communicate with each other according to process flow diagram 900.

At 905, the UE 115-h may receive, from the network entity 105-h, resource allocation tables (e.g., control signaling indicating a resource allocation table). The control signaling may indicate a frequency resource allocation table supporting multiple transmissions across multiple frequency bands corresponding to a single control message and a time resource allocation table supporting multiple transmissions across multiple time intervals corresponding to the single control message. Although illustrated with reference to frequency bands, techniques described herein may also apply to any range of frequency resources (e.g., frequency bands, subbands, slots, among other examples). In some examples, the frequency band (e.g., or any range of frequency resources) may be consecutive or non-consecutive.

Receiving the control signaling may include receiving an RRC message indicating the frequency resource allocation table, where the FDRA field includes an index indicating a row in the frequency resource allocation table associated with the multiple messages. The row in the frequency resource allocation table may be associated with the index indicating one or more common parameters associated with communicating the plurality of messages via the plurality of frequency bands, one or more message-specific parameters associated with communicating each respective message of the multiple messages via the multiple frequency bands, or a combination thereof.

At 910, the UE 115-h may receive, from the network entity 105-h, a message threshold. The message threshold may include control signaling indicating a threshold number (e.g., quantity) of messages, where the threshold quantity of messages may be associated with the control message, where communicating the multiple messages is based on determining that a number of the multiple messages satisfies the threshold quantity of messages.

At 915, the UE 115-h may receive, from the network entity 105-h, a control message. The control message may schedule multiple messages, and may include a FDRA field and a TDRA field indicating multiple frequency bands and one or more time intervals according to the time resource allocation table and the frequency resource allocation table.

The control message may include, in FDRA field of the control message, an indication of the multiple frequency bands that are associated with a first time interval of multiple time intervals including the one or more time intervals. In some examples, the control message may include, in TDRA field of the control message, an indication of one or more remaining time intervals of the multiple time intervals.

In some examples, receiving the control message may include receiving, in the FDRA field of the control message, an indication of the multiple frequency bands that are associated with each of one or more time intervals including the one or more time intervals, and in the TDRA field of the control message, an indication of the more than one time intervals.

At 920, the UE 115-h may drop one or more messages of a total quantity of messages scheduled by the control message according to the threshold quantity of messages scheduled according to a prioritization of the total quantity of messages that is based on the one or more time intervals, the multiple frequency bands, or a combination thereof. The first message may occur during a first time offset after the control message, and may have a higher priority level than a second message occurring a second time offset that is larger than the first time offset after the control message. In some examples, the first message may occur a first time offset after the control message that has a higher priority level than a second message occurring a second time offset that is shorter than the first time offset after the control message.

At 925, the UE 115-h and the network entity 105-h may communicate wireless messages with each other. The UE 115-h and the network entity 105-h may communicate, via multiple frequency bands and the one or more time intervals, the multiple wireless messages according to the FDRA field and the TDRA field.

Communicating the wireless messages may include communicating multiple messages via the multiple frequency bands during the first time interval, and communicating a remaining one or more messages via a single frequency band of the multiple of frequency bands across the one or more remaining time intervals of the multiple time intervals.

In some examples, communicating the wireless messages may include communicating the multiple messages via the multiple frequency bands during each of the time intervals, transmitting or receiving multiple uplink transmissions on an uplink shared channel, or transmitting or receiving a multiple downlink transmissions on a downlink shared channel.

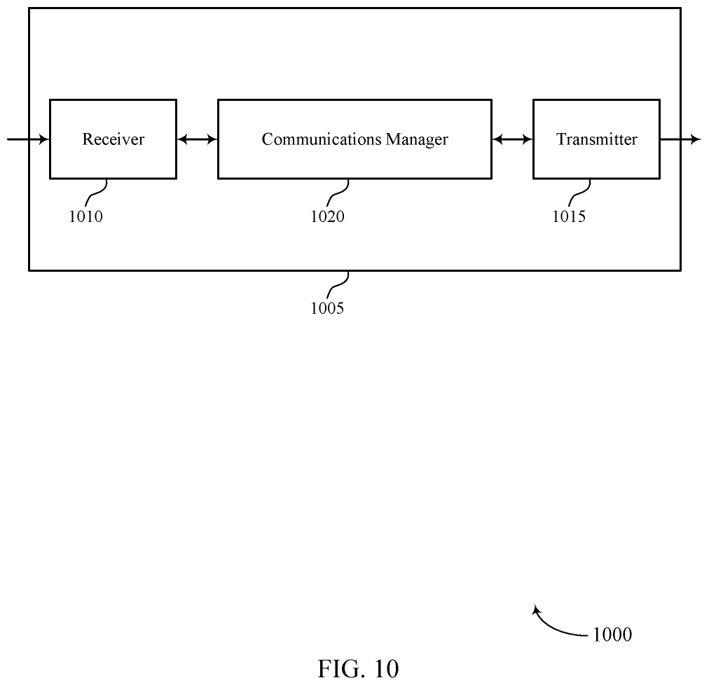

FIG. 10 shows a block diagram 1000 of a device 1005 that supports single DCI scheduling multiple uplink shared channels across time and frequency in accordance with one or more aspects of the present disclosure. The device 1005 may be an example of aspects of a UE 115 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for receiving information such as packets, user data, control information, or any combination thereof associated with various information channels (e.g., control channels, data channels, information channels related to single DCI scheduling multiple uplink shared channels across time and frequency). Information may be passed on to other components of the device 1005. The receiver 1010 may utilize a single antenna or a set of multiple antennas.

The transmitter 1015 may provide a means for transmitting signals generated by other components of the device 1005. For example, the transmitter 1015 may transmit information such as packets, user data, control information, or any combination thereof associated with various information channels (e.g., control channels, data channels, information channels related to single DCI scheduling multiple uplink shared channels across time and frequency). In some examples, the transmitter 1015 may be co-located with a receiver 1010 in a transceiver module. The transmitter 1015 may utilize a single antenna or a set of multiple antennas.

The communications manager 1020, the receiver 1010, the transmitter 1015, or various combinations thereof or various components thereof may be examples of means for performing various aspects of single DCI scheduling multiple uplink shared channels across time and frequency as described herein. For example, the communications manager 1020, the receiver 1010, the transmitter 1015, or various combinations or components thereof may support a method for performing one or more of the functions described herein.

In some examples, the communications manager 1020, the receiver 1010, the transmitter 1015, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1020, the receiver 1010, the transmitter 1015, or various combinations or components thereof may be implemented in code (e.g., as communications management software or firmware) executed by a processor. If implemented in code executed by a processor, the functions of the communications manager 1020, the receiver 1010, the transmitter 1015, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 1020 may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications at a UE in accordance with examples as disclosed herein. For example, the communications manager 1020 may be configured as or otherwise support a means for receiving, from a network entity, control signaling indicating a frequency resource allocation table supporting multiple transmissions across multiple frequency bands corresponding to a single control message and a time resource allocation table supporting multiple transmissions across multiple time intervals corresponding to the single control message. The communications manager 1020 may be configured as or otherwise support a means for receiving, from the network entity, a control message scheduling a set of multiple messages, the control message including a FDRA field and a TDRA field indicating a set of multiple frequency bands and one or more time intervals according to the time resource allocation table and the frequency resource allocation table. The communications manager 1020 may be configured as or otherwise support a means for communicating, via the set of multiple frequency bands and the one or more time intervals, the set of multiple messages with the network entity according to the FDRA field and the TDRA field.

By including or configuring the communications manager 1020 in accordance with examples as described herein, the device 1005 (e.g., a processor controlling or otherwise coupled with the receiver 1010, the transmitter 1015, the communications manager 1020, or a combination thereof) may support techniques for scheduling multiple uplink shared channels across time and frequency, which may result in improved efficiency, increased throughput, reduced power consumption, and more efficient utilization of communication resources, among other advantages.

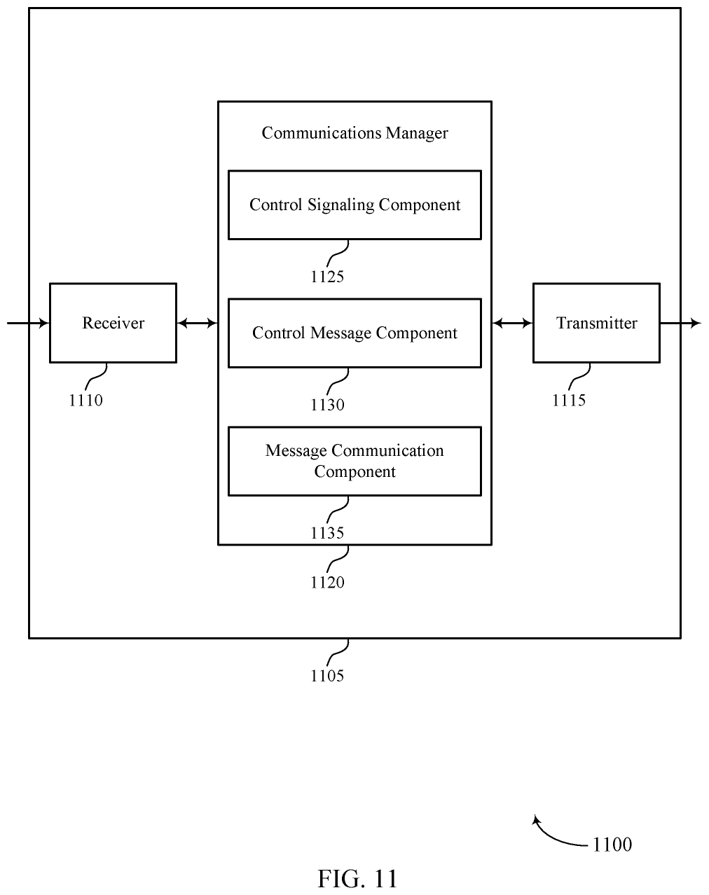

FIG. 11 shows a block diagram 1100 of a device 1105 that supports single DCI scheduling multiple uplink shared channels across time and frequency in accordance with one or more aspects of the present disclosure. The device 1105 may be an example of aspects of a device 1005 or a UE 115 as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for receiving information such as packets, user data, control information, or any combination thereof associated with various information channels (e.g., control channels, data channels, information channels related to single DCI scheduling multiple uplink shared channels across time and frequency). Information may be passed on to other components of the device 1105. The receiver 1110 may utilize a single antenna or a set of multiple antennas.

The transmitter 1115 may provide a means for transmitting signals generated by other components of the device 1105. For example, the transmitter 1115 may transmit information such as packets, user data, control information, or any combination thereof associated with various information channels (e.g., control channels, data channels, information channels related to single DCI scheduling multiple uplink shared channels across time and frequency). In some examples, the transmitter 1115 may be co-located with a receiver 1110 in a transceiver module. The transmitter 1115 may utilize a single antenna or a set of multiple antennas.

The device 1105, or various components thereof, may be an example of means for performing various aspects of single DCI scheduling multiple uplink shared channels across time and frequency as described herein. For example, the communications manager 1120 may include a control signaling component 1125, a control message component 1130, a message communication component 1135, or any combination thereof. The communications manager 1120 may be an example of aspects of a communications manager 1020 as described herein. In some examples, the communications manager 1120, or various components thereof, may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communications at a UE in accordance with examples as disclosed herein. The control signaling component 1125 may be configured as or otherwise support a means for receiving, from a network entity, control signaling indicating a frequency resource allocation table supporting multiple transmissions across multiple frequency bands corresponding to a single control message and a time resource allocation table supporting multiple transmissions across multiple time intervals corresponding to the single control message. The control message component 1130 may be configured as or otherwise support a means for receiving, from the network entity, a control message scheduling a set of multiple messages, the control message including a FDRA field and a TDRA field indicating a set of multiple frequency bands and one or more time intervals according to the time resource allocation table and the frequency resource allocation table. The message communication component 1135 may be configured as or otherwise support a means for communicating, via the set of multiple frequency bands and the one or more time intervals, the set of multiple messages with the network entity according to the FDRA field and the TDRA field.

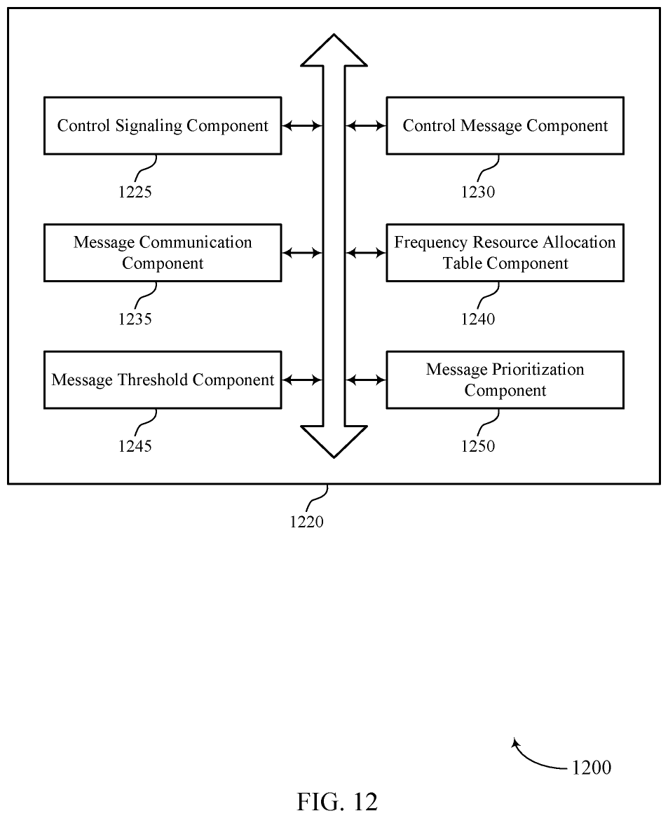

FIG. 12 shows a block diagram 1200 of a communications manager 1220 that supports single DCI scheduling multiple uplink shared channels across time and frequency in accordance with one or more aspects of the present disclosure. The communications manager 1220 may be an example of aspects of a communications manager 1020, a communications manager 1120, or both, as described herein. The communications manager 1220, or various components thereof, may be an example of means for performing various aspects of single DCI scheduling multiple uplink shared channels across time and frequency as described herein. For example, the communications manager 1220 may include a control signaling component 1225, a control message component 1230, a message communication component 1235, a frequency resource allocation table component 1240, a message threshold component 1245, a message prioritization component 1250, or any combination thereof. Each of these components may communicate, directly or indirectly, with one another (e.g., via one or more buses).

The communications manager 1220 may support wireless communications at a UE in accordance with examples as disclosed herein. The control signaling component 1225 may be configured as or otherwise support a means for receiving, from a network entity, control signaling indicating a frequency resource allocation table supporting multiple transmissions across multiple frequency bands corresponding to a single control message and a time resource allocation table supporting multiple transmissions across multiple time intervals corresponding to the single control message. The control message component 1230 may be configured as or otherwise support a means for receiving, from the network entity, a control message scheduling a set of multiple messages, the control message including a FDRA field and a TDRA field indicating a set of multiple frequency bands and one or more time intervals according to the time resource allocation table and the frequency resource allocation table. The message communication component 1235 may be configured as or otherwise support a means for communicating, via the set of multiple frequency bands and the one or more time intervals, the set of multiple messages with the network entity according to the FDRA field and the TDRA field.

In some examples, to support receiving the control signaling, the frequency resource allocation table component 1240 may be configured as or otherwise support a means for receiving a RRC message including the frequency resource allocation table, where the FDRA field includes an index indicating a row in the frequency resource allocation table associated with the set of multiple messages.

In some examples, the row in the frequency resource allocation table associated with the index indicates one or more common parameters associated with communicating the set of multiple messages via the set of multiple frequency bands, one or more message-specific parameters associated with communicating each respective message of the set of multiple messages via the set of multiple frequency bands, or a combination thereof.

In some examples, to support receiving the control message, the control message component 1230 may be configured as or otherwise support a means for receiving, in the FDRA field of the control message, an indication of the set of multiple frequency bands that are associated with a first time interval of a set of multiple time intervals including the one or more time intervals. In some examples, to support receiving the control message, the control message component 1230 may be configured as or otherwise support a means for receiving, in the TDRA field of the control message, an indication of one or more remaining time intervals of the set of multiple time intervals.

In some examples, to support communicating the set of multiple messages, the message communication component 1235 may be configured as or otherwise support a means for communicating multiple messages of the set of multiple messages via the set of multiple frequency bands during the first time interval. In some examples, to support communicating the set of multiple messages, the message communication component 1235 may be configured as or otherwise support a means for communicating a remaining one or more messages of the set of multiple messages via a single frequency band of the set of multiple frequency bands across the one or more remaining time intervals of the set of multiple time intervals.

In some examples, to support receiving the control message, the control message component 1230 may be configured as or otherwise support a means for receiving, in the FDRA field of the control message, an indication of the set of multiple frequency bands that are associated with each of a set of multiple time intervals including the one or more time intervals. In some examples, to support receiving the control message, the control message component 1230 may be configured as or otherwise support a means for receiving, in the TDRA field of the control message, an indication of the set of multiple time intervals.

In some examples, to support communicating the set of multiple messages, the message communication component 1235 may be configured as or otherwise support a means for communicating the set of multiple messages via the set of multiple frequency bands during each of the set of multiple time intervals.

In some examples, the message threshold component 1245 may be configured as or otherwise support a means for receiving control signaling indicating a threshold quantity of messages associated with the control message, where communicating the set of multiple messages is based on determining that a quantity of the set of multiple messages satisfies the threshold quantity of messages.

In some examples, the message prioritization component 1250 may be configured as or otherwise support a means for dropping one or more messages of a total quantity of messages scheduled by the control message according to the threshold quantity of messages scheduled according to a prioritization of the total quantity of messages that is based on the one or more time intervals, the set of multiple frequency bands, or a combination thereof.

In some examples, a first message occurring a first time offset after the control message has a higher priority level than a second message occurring a second time offset that is larger than the first time offset after the control message.

In some examples, a first message occurring a first time offset after the control message has a higher priority level than a second message occurring a second time offset that is shorter than the first time offset after the control message.

In some examples, to support communicating the set of multiple messages with the network entity, the message communication component 1235 may be configured as or otherwise support a means for transmitting a set of multiple uplink transmissions on an uplink shared channel.

In some examples, to support communicating the set of multiple messages with the network entity, the message communication component 1235 may be configured as or otherwise support a means for receiving a set of multiple downlink transmissions on a downlink shared channel.

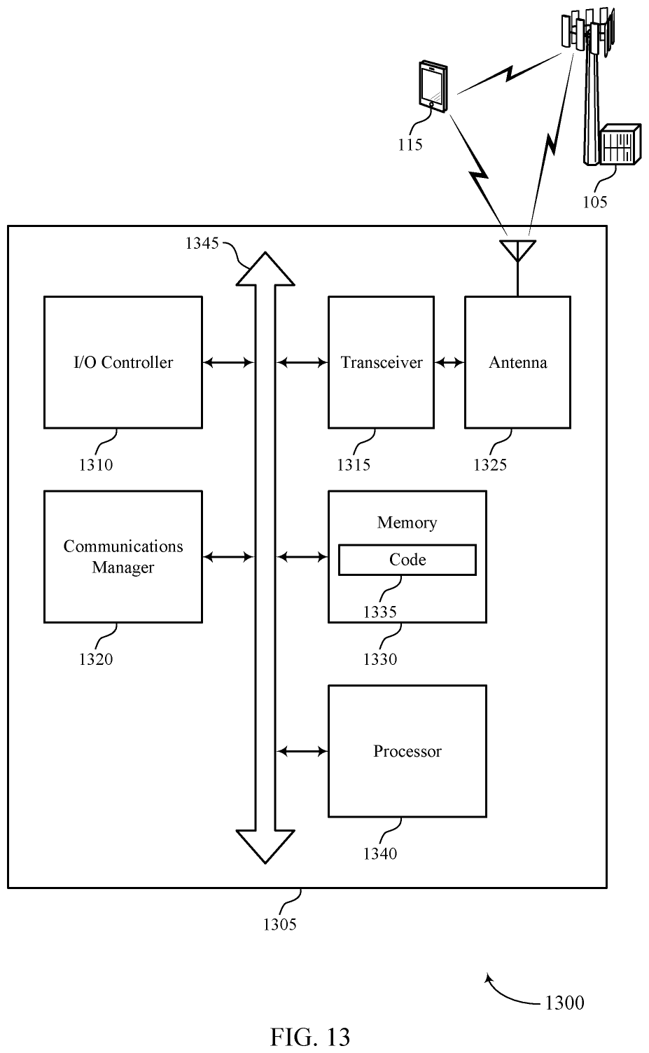

FIG. 13 shows a diagram of a system 1300 including a device 1305 that supports single DCI scheduling multiple uplink shared channels across time and frequency in accordance with one or more aspects of the present disclosure. The device 1305 may be an example of or include the components of a device 1005, a device 1105, or a UE 115 as described herein. The device 1305 may communicate (e.g., wirelessly) with one or more network entities 105, one or more UEs 115, or any combination thereof. The device 1305 may include components for bi-directional voice and data communications including components for transmitting and receiving communications, such as a communications manager 1320, an input/output (I/O) controller 1310, a transceiver 1315, an antenna 1325, a memory 1330, code 1335, and a processor 1340. These components may be in electronic communication or otherwise coupled (e.g., operatively, communicatively, functionally, electronically, electrically) via one or more buses (e.g., a bus 1345).

The I/O controller 1310 may manage input and output signals for the device 1305. The I/O controller 1310 may also manage peripherals not integrated into the device 1305. In some cases, the I/O controller 1310 may represent a physical connection or port to an external peripheral. In some cases, the I/O controller 1310 may utilize an operating system such as iOS®, ANDROID®, MS-DOS®, MS-WINDOWS®, OS/2®, UNIX®, LINUX®, or another known operating system. Additionally or alternatively, the I/O controller 1310 may represent or interact with a modem, a keyboard, a mouse, a touchscreen, or a similar device. In some cases, the I/O controller 1310 may be implemented as part of a processor, such as the processor 1340. In some cases, a user may interact with the device 1305 via the I/O controller 1310 or via hardware components controlled by the I/O controller 1310.

In some cases, the device 1305 may include a single antenna 1325. However, in some other cases, the device 1305 may have more than one antenna 1325, which may be capable of concurrently transmitting or receiving multiple wireless transmissions. The transceiver 1315 may communicate bi-directionally, via the one or more antennas 1325, wired, or wireless links as described herein. For example, the transceiver 1315 may represent a wireless transceiver and may communicate bi-directionally with another wireless transceiver. The transceiver 1315 may also include a modem to modulate the packets, to provide the modulated packets to one or more antennas 1325 for transmission, and to demodulate packets received from the one or more antennas 1325. The transceiver 1315, or the transceiver 1315 and one or more antennas 1325, may be an example of a transmitter 1015, a transmitter 1115, a receiver 1010, a receiver 1110, or any combination thereof or component thereof, as described herein.

The memory 1330 may include random access memory (RAM) and read-only memory (ROM). The memory 1330 may store computer-readable, computer-executable code 1335 including instructions that, when executed by the processor 1340, cause the device 1305 to perform various functions described herein. The code 1335 may be stored in a non-transitory computer-readable medium such as system memory or another type of memory. In some cases, the code 1335 may not be directly executable by the processor 1340 but may cause a computer (e.g., when compiled and executed) to perform functions described herein. In some cases, the memory 1330 may contain, among other things, a basic I/O system (BIOS) which may control basic hardware or software operation such as the interaction with peripheral components or devices.

The processor 1340 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1340 may be configured to operate a memory array using a memory controller. In some other cases, a memory controller may be integrated into the processor 1340. The processor 1340 may be configured to execute computer-readable instructions stored in a memory (e.g., the memory 1330) to cause the device 1305 to perform various functions (e.g., functions or tasks supporting single DCI scheduling multiple uplink shared channels across time and frequency). For example, the device 1305 or a component of the device 1305 may include a processor 1340 and memory 1330 coupled with or to the processor 1340, the processor 1340 and memory 1330 configured to perform various functions described herein.

The communications manager 1320 may support wireless communications at a UE in accordance with examples as disclosed herein. For example, the communications manager 1320 may be configured as or otherwise support a means for receiving, from a network entity, control signaling indicating a frequency resource allocation table supporting multiple transmissions across multiple frequency bands corresponding to a single control message and a time resource allocation table supporting multiple transmissions across multiple time intervals corresponding to the single control message. The communications manager 1320 may be configured as or otherwise support a means for receiving, from the network entity, a control message scheduling a set of multiple messages, the control message including a FDRA field and a TDRA field indicating a set of multiple frequency bands and one or more time intervals according to the time resource allocation table and the frequency resource allocation table. The communications manager 1320 may be configured as or otherwise support a means for communicating, via the set of multiple frequency bands and the one or more time intervals, the set of multiple messages with the network entity according to the FDRA field and the TDRA field.

By including or configuring the communications manager 1320 in accordance with examples as described herein, the device 1305 may support techniques for scheduling multiple uplink shared channels across time and frequency, which may result in improved communication reliability, reduced latency, improved user experience, reduced processing, reduced power consumption, more efficient utilization of communication resources, and increased battery life, among other advantages.

In some examples, the communications manager 1320 may be configured to perform various operations (e.g., receiving, monitoring, transmitting) using or otherwise in cooperation with the transceiver 1315, the one or more antennas 1325, or any combination thereof. Although the communications manager 1320 is illustrated as a separate component, in some examples, one or more functions described with reference to the communications manager 1320 may be supported by or performed by the processor 1340, the memory 1330, the code 1335, or any combination thereof. For example, the code 1335 may include instructions executable by the processor 1340 to cause the device 1305 to perform various aspects of single DCI scheduling multiple uplink shared channels across time and frequency as described herein, or the processor 1340 and the memory 1330 may be otherwise configured to perform or support such operations.

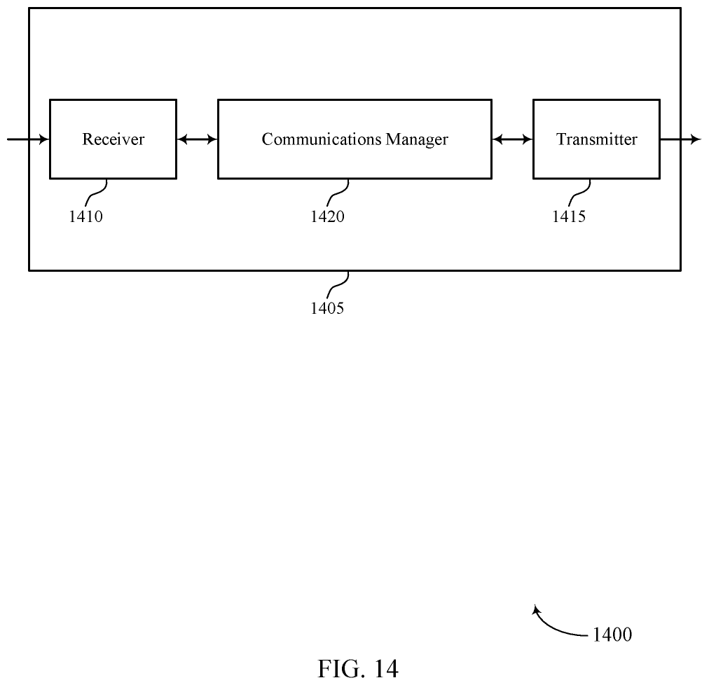

FIG. 14 shows a block diagram 1400 of a device 1405 that supports single DCI scheduling multiple uplink shared channels across time and frequency in accordance with one or more aspects of the present disclosure. The device 1405 may be an example of aspects of a network entity 105 as described herein. The device 1405 may include a receiver 1410, a transmitter 1415, and a communications manager 1420. The device 1405 may also include a processor. Each of these components may be in communication with one another (e.g., via one or more buses).

The receiver 1410 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1405. In some examples, the receiver 1410 may support obtaining information by receiving signals via one or more antennas. Additionally, or alternatively, the receiver 1410 may support obtaining information by receiving signals via one or more wired (e.g., electrical, fiber optic) interfaces, wireless interfaces, or any combination thereof.

The transmitter 1415 may provide a means for outputting (e.g., transmitting, providing, conveying, sending) information generated by other components of the device 1405. For example, the transmitter 1415 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1415 may support outputting information by transmitting signals via one or more antennas. Additionally, or alternatively, the transmitter 1415 may support outputting information by transmitting signals via one or more wired (e.g., electrical, fiber optic) interfaces, wireless interfaces, or any combination thereof. In some examples, the transmitter 1415 and the receiver 1410 may be co-located in a transceiver, which may include or be coupled with a modem.

The communications manager 1420, the receiver 1410, the transmitter 1415, or various combinations thereof or various components thereof may be examples of means for performing various aspects of single DCI scheduling multiple uplink shared channels across time and frequency as described herein. For example, the communications manager 1420, the receiver 1410, the transmitter 1415, or various combinations or components thereof may support a method for performing one or more of the functions described herein.

In some examples, the communications manager 1420, the receiver 1410, the transmitter 1415, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1420, the receiver 1410, the transmitter 1415, or various combinations or components thereof may be implemented in code (e.g., as communications management software or firmware) executed by a processor. If implemented in code executed by a processor, the functions of the communications manager 1420, the receiver 1410, the transmitter 1415, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 1420 may be configured to perform various operations (e.g., receiving, obtaining, monitoring, outputting, transmitting) using or otherwise in cooperation with the receiver 1410, the transmitter 1415, or both. For example, the communications manager 1420 may receive information from the receiver 1410, send information to the transmitter 1415, or be integrated in combination with the receiver 1410, the transmitter 1415, or both to obtain information, output information, or perform various other operations as described herein.

The communications manager 1420 may support wireless communications at a network entity in accordance with examples as disclosed herein. For example, the communications manager 1420 may be configured as or otherwise support a means for transmitting, to a UE, control signaling indicating a frequency resource allocation table supporting multiple transmissions across multiple frequency bands corresponding to a single control message and a time resource allocation table supporting multiple transmissions across multiple time intervals corresponding to the single control message. The communications manager 1420 may be configured as or otherwise support a means for transmitting, to the UE, a control message scheduling a set of multiple messages, the control message including a FDRA field and a TDRA field indicating a set of multiple frequency bands and one or more time intervals according to the time resource allocation table and the frequency resource allocation table. The communications manager 1420 may be configured as or otherwise support a means for communicating, via the set of multiple frequency bands and the one or more time intervals, the set of multiple messages with the UE according to the FDRA field and the TDRA field.

By including or configuring the communications manager 1420 in accordance with examples as described herein, the device 1405 (e.g., a processor controlling or otherwise coupled with the receiver 1410, the transmitter 1415, the communications manager 1420, or a combination thereof) may support techniques for scheduling multiple uplink shared channels across time and frequency, which may result in increased throughput, decreased system latency, reduced power consumption, and more efficient utilization of communication resources, among other advantages.

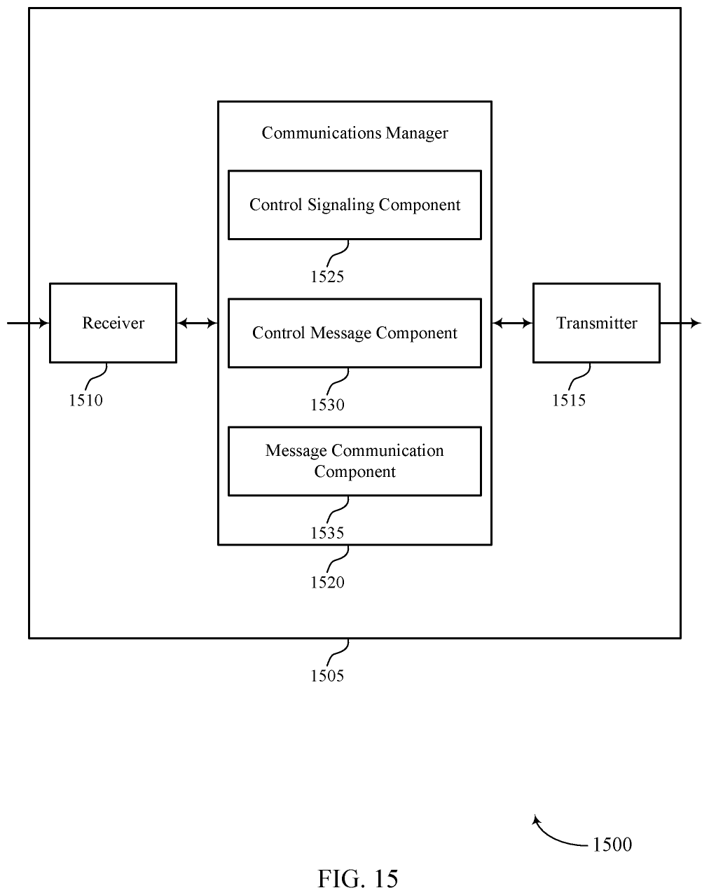

FIG. 15 shows a block diagram 1500 of a device 1505 that supports single DCI scheduling multiple uplink shared channels across time and frequency in accordance with one or more aspects of the present disclosure. The device 1505 may be an example of aspects of a device 1405 or a network entity 105 as described herein. The device 1505 may include a receiver 1510, a transmitter 1515, and a communications manager 1520. The device 1505 may also include a processor. Each of these components may be in communication with one another (e.g., via one or more buses).

The receiver 1510 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1505. In some examples, the receiver 1510 may support obtaining information by receiving signals via one or more antennas. Additionally, or alternatively, the receiver 1510 may support obtaining information by receiving signals via one or more wired (e.g., electrical, fiber optic) interfaces, wireless interfaces, or any combination thereof.

The transmitter 1515 may provide a means for outputting (e.g., transmitting, providing, conveying, sending) information generated by other components of the device 1505. For example, the transmitter 1515 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1515 may support outputting information by transmitting signals via one or more antennas. Additionally, or alternatively, the transmitter 1515 may support outputting information by transmitting signals via one or more wired (e.g., electrical, fiber optic) interfaces, wireless interfaces, or any combination thereof. In some examples, the transmitter 1515 and the receiver 1510 may be co-located in a transceiver, which may include or be coupled with a modem.

The device 1505, or various components thereof, may be an example of means for performing various aspects of single DCI scheduling multiple uplink shared channels across time and frequency as described herein. For example, the communications manager 1520 may include a control signaling component 1525, a control message component 1530, a message communication component 1535, or any combination thereof. The communications manager 1520 may be an example of aspects of a communications manager 1420 as described herein. In some examples, the communications manager 1520, or various components thereof, may be configured to perform various operations (e.g., receiving, obtaining, monitoring, outputting, transmitting) using or otherwise in cooperation with the receiver 1510, the transmitter 1515, or both. For example, the communications manager 1520 may receive information from the receiver 1510, send information to the transmitter 1515, or be integrated in combination with the receiver 1510, the transmitter 1515, or both to obtain information, output information, or perform various other operations as described herein.

The communications manager 1520 may support wireless communications at a network entity in accordance with examples as disclosed herein. The control signaling component 1525 may be configured as or otherwise support a means for transmitting, to a UE, control signaling indicating a frequency resource allocation table supporting multiple transmissions across multiple frequency bands corresponding to a single control message and a time resource allocation table supporting multiple transmissions across multiple time intervals corresponding to the single control message. The control message component 1530 may be configured as or otherwise support a means for transmitting, to the UE, a control message scheduling a set of multiple messages, the control message including a FDRA field and a TDRA field indicating a set of multiple frequency bands and one or more time intervals according to the time resource allocation table and the frequency resource allocation table. The message communication component 1535 may be configured as or otherwise support a means for communicating, via the set of multiple frequency bands and the one or more time intervals, the set of multiple messages with the UE according to the FDRA field and the TDRA field.

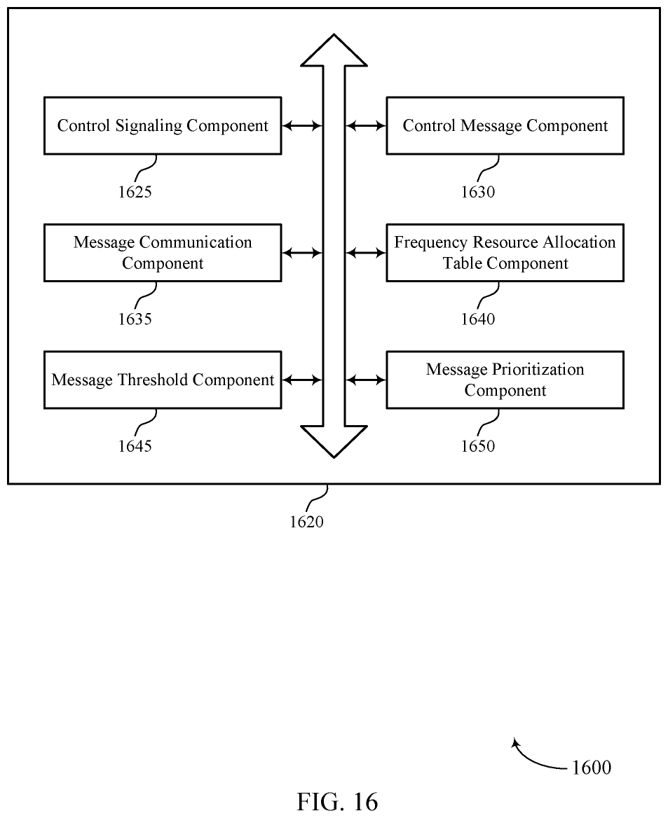

FIG. 16 shows a block diagram 1600 of a communications manager 1620 that supports single DCI scheduling multiple uplink shared channels across time and frequency in accordance with one or more aspects of the present disclosure. The communications manager 1620 may be an example of aspects of a communications manager 1420, a communications manager 1520, or both, as described herein. The communications manager 1620, or various components thereof, may be an example of means for performing various aspects of single DCI scheduling multiple uplink shared channels across time and frequency as described herein. For example, the communications manager 1620 may include a control signaling component 1625, a control message component 1630, a message communication component 1635, a frequency resource allocation table component 1640, a message threshold component 1645, a message prioritization component 1650, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1620 may support wireless communications at a network entity in accordance with examples as disclosed herein. The control signaling component 1625 may be configured as or otherwise support a means for transmitting, to a UE, control signaling indicating a frequency resource allocation table supporting multiple transmissions across multiple frequency bands corresponding to a single control message and a time resource allocation table supporting multiple transmissions across multiple time intervals corresponding to the single control message. The control message component 1630 may be configured as or otherwise support a means for transmitting, to the UE, a control message scheduling a set of multiple messages, the control message including a FDRA field and a TDRA field indicating a set of multiple frequency bands and one or more time intervals according to the time resource allocation table and the frequency resource allocation table. The message communication component 1635 may be configured as or otherwise support a means for communicating, via the set of multiple frequency bands and the one or more time intervals, the set of multiple messages with the UE according to the FDRA field and the TDRA field.

In some examples, to support transmitting the control signaling, the frequency resource allocation table component 1640 may be configured as or otherwise support a means for transmitting a RRC message including the frequency resource allocation table, where the FDRA field includes an index indicating a row in the frequency resource allocation table associated with the set of multiple messages.

In some examples, the row in the frequency resource allocation table associated with the index indicates one or more common parameters associated with communicating the set of multiple messages via the set of multiple frequency bands, one or more message-specific parameters associated with communicating each respective message of the set of multiple messages via the set of multiple frequency bands, or a combination thereof.

In some examples, to support transmitting the control message, the control message component 1630 may be configured as or otherwise support a means for transmitting, in the FDRA field of the control message, an indication of the set of multiple frequency bands that are associated with a first time interval of a set of multiple time intervals including the one or more time intervals. In some examples, to support transmitting the control message, the control message component 1630 may be configured as or otherwise support a means for transmitting, in the TDRA field of the control message, an indication of one or more remaining time intervals of the set of multiple time intervals.

In some examples, to support communicating the set of multiple messages, the message communication component 1635 may be configured as or otherwise support a means for communicating multiple messages of the set of multiple messages via the set of multiple frequency bands during the first time interval. In some examples, to support communicating the set of multiple messages, the message communication component 1635 may be configured as or otherwise support a means for communicating a remaining one or more messages of the set of multiple messages via a single frequency band of the set of multiple frequency bands across the one or more remaining time intervals of the set of multiple time intervals.

In some examples, to support transmitting the control message, the control message component 1630 may be configured as or otherwise support a means for transmitting, in the FDRA field of the control message, an indication of the set of multiple frequency bands that are associated with each of a set of multiple time intervals including the one or more time intervals. In some examples, to support transmitting the control message, the control message component 1630 may be configured as or otherwise support a means for transmitting, in the TDRA field of the control message, an indication of the set of multiple time intervals.

In some examples, to support communicating the set of multiple messages, the message communication component 1635 may be configured as or otherwise support a means for communicating the set of multiple messages via the set of multiple frequency bands during each of the set of multiple time intervals.

In some examples, the message threshold component 1645 may be configured as or otherwise support a means for transmitting control signaling indicating a threshold quantity of messages associated with the control message, where communicating the set of multiple messages is based on determining that a quantity of the set of multiple messages satisfies the threshold quantity of messages.

In some examples, the message prioritization component 1650 may be configured as or otherwise support a means for dropping one or more messages of a total quantity of messages scheduled by the control message according to the threshold quantity of messages scheduled according to a prioritization of the total quantity of messages that is based on the one or more time intervals, the set of multiple frequency bands, or a combination thereof.

In some examples, a first message occurring a first time offset after the control message has a higher priority level than a second message occurring a second time offset that is larger than the first time offset after the control message.

In some examples, a first message occurring a first time offset after the control message has a higher priority level than a second message occurring a second time offset that is shorter than the first time offset after the control message.

In some examples, to support communicating the set of multiple messages with the UE, the message communication component 1635 may be configured as or otherwise support a means for receiving a set of multiple uplink transmissions on an uplink shared channel.

In some examples, to support communicating the set of multiple messages with the UE, the message communication component 1635 may be configured as or otherwise support a means for transmitting a set of multiple downlink transmissions on a downlink shared channel.

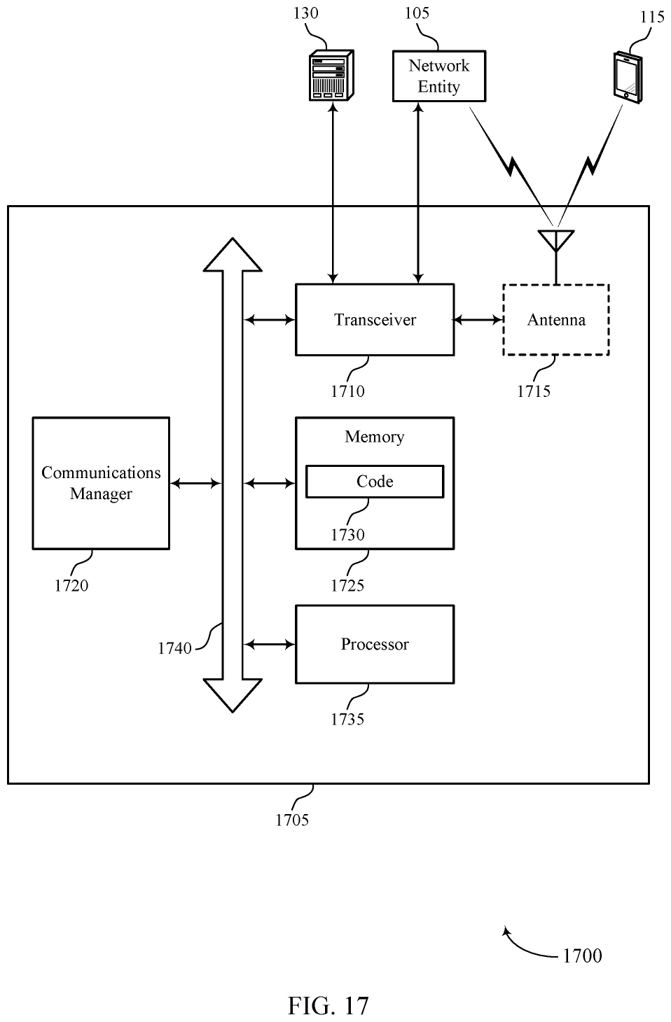

FIG. 17 shows a diagram of a system 1700 including a device 1705 that supports single DCI scheduling multiple uplink shared channels across time and frequency in accordance with one or more aspects of the present disclosure. The device 1705 may be an example of or include the components of a device 1405, a device 1505, or a network entity 105 as described herein. The device 1705 may communicate with one or more network entities 105, one or more UEs 115, or any combination thereof, which may include communications over one or more wired interfaces, over one or more wireless interfaces, or any combination thereof. The device 1705 may include components that support outputting and obtaining communications, such as a communications manager 1720, a transceiver 1710, an antenna 1715, a memory 1725, code 1730, and a processor 1735. These components may be in electronic communication or otherwise coupled (e.g., operatively, communicatively, functionally, electronically, electrically) via one or more buses (e.g., a bus 1740).

The transceiver 1710 may support bi-directional communications via wired links, wireless links, or both as described herein. In some examples, the transceiver 1710 may include a wired transceiver and may communicate bi-directionally with another wired transceiver. Additionally, or alternatively, in some examples, the transceiver 1710 may include a wireless transceiver and may communicate bi-directionally with another wireless transceiver. In some examples, the device 1705 may include one or more antennas 1715, which may be capable of transmitting or receiving wireless transmissions (e.g., concurrently). The transceiver 1710 may also include a modem to modulate signals, to provide the modulated signals for transmission (e.g., by one or more antennas 1715, by a wired transmitter), to receive modulated signals (e.g., from one or more antennas 1715, from a wired receiver), and to demodulate signals. In some implementations, the transceiver 1710 may include one or more interfaces, such as one or more interfaces coupled with the one or more antennas 1715 that are configured to support various receiving or obtaining operations, or one or more interfaces coupled with the one or more antennas 1715 that are configured to support various transmitting or outputting operations, or a combination thereof. In some implementations, the transceiver 1710 may include or be configured for coupling with one or more processors or memory components that are operable to perform or support operations based on received or obtained information or signals, or to generate information or other signals for transmission or other outputting, or any combination thereof. In some implementations, the transceiver 1710, or the transceiver 1710 and the one or more antennas 1715, or the transceiver 1710 and the one or more antennas 1715 and one or more processors or memory components (for example, the processor 1735, or the memory 1725, or both), may be included in a chip or chip assembly that is installed in the device 1705. In some examples, the transceiver may be operable to support communications via one or more communications links (e.g., a communication link 125, a backhaul communication link 120, a midhaul communication link 162, a fronthaul communication link 168).

The memory 1725 may include RAM and ROM. The memory 1725 may store computer-readable, computer-executable code 1730 including instructions that, when executed by the processor 1735, cause the device 1705 to perform various functions described herein. The code 1730 may be stored in a non-transitory computer-readable medium such as system memory or another type of memory. In some cases, the code 1730 may not be directly executable by the processor 1735 but may cause a computer (e.g., when compiled and executed) to perform functions described herein. In some cases, the memory 1725 may contain, among other things, a BIOS which may control basic hardware or software operation such as the interaction with peripheral components or devices.

The processor 1735 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1735 may be configured to operate a memory array using a memory controller. In some other cases, a memory controller may be integrated into the processor 1735. The processor 1735 may be configured to execute computer-readable instructions stored in a memory (e.g., the memory 1725) to cause the device 1705 to perform various functions (e.g., functions or tasks supporting single DCI scheduling multiple uplink shared channels across time and frequency). For example, the device 1705 or a component of the device 1705 may include a processor 1735 and memory 1725 coupled with the processor 1735, the processor 1735 and memory 1725 configured to perform various functions described herein. The processor 1735 may be an example of a cloud-computing platform (e.g., one or more physical nodes and supporting software such as operating systems, virtual machines, or container instances) that may host the functions (e.g., by executing code 1730) to perform the functions of the device 1705. The processor 1735 may be any one or more suitable processors capable of executing scripts or instructions of one or more software programs stored in the device 1705 (such as within the memory 1725). In some implementations, the processor 1735 may be a component of a processing system. A processing system may generally refer to a system or series of machines or components that receives inputs and processes the inputs to produce a set of outputs (which may be passed to other systems or components of, for example, the device 1705). For example, a processing system of the device 1705 may refer to a system including the various other components or subcomponents of the device 1705, such as the processor 1735, or the transceiver 1710, or the communications manager 1720, or other components or combinations of components of the device 1705. The processing system of the device 1705 may interface with other components of the device 1705, and may process information received from other components (such as inputs or signals) or output information to other components. For example, a chip or modem of the device 1705 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1705 may transmit information output from the chip or modem. Additionally, or alternatively, in some implementations, the one or more interfaces may refer to an interface between the processing system of the chip or modem and a receiver, such that the device 1705 may obtain information or signal inputs, and the information may be passed to the processing system. A person having ordinary skill in the art will readily recognize that a first interface also may obtain information or signal inputs, and a second interface also may output information or signal outputs.

In some examples, a bus 1740 may support communications of (e.g., within) a protocol layer of a protocol stack. In some examples, a bus 1740 may support communications associated with a logical channel of a protocol stack (e.g., between protocol layers of a protocol stack), which may include communications performed within a component of the device 1705, or between different components of the device 1705 that may be co-located or located in different locations (e.g., where the device 1705 may refer to a system in which one or more of the communications manager 1720, the transceiver 1710, the memory 1725, the code 1730, and the processor 1735 may be located in one of the different components or divided between different components).

In some examples, the communications manager 1720 may manage aspects of communications with a core network 130 (e.g., via one or more wired or wireless backhaul links). For example, the communications manager 1720 may manage the transfer of data communications for client devices, such as one or more UEs 115. In some examples, the communications manager 1720 may manage communications with other network entities 105, and may include a controller or scheduler for controlling communications with UEs 115 in cooperation with other network entities 105. In some examples, the communications manager 1720 may support an X2 interface within an LTE/LTE-A wireless communications network technology to provide communication between network entities 105.

The communications manager 1720 may support wireless communications at a network entity in accordance with examples as disclosed herein. For example, the communications manager 1720 may be configured as or otherwise support a means for transmitting, to a UE, control signaling indicating a frequency resource allocation table supporting multiple transmissions across multiple frequency bands corresponding to a single control message and a time resource allocation table supporting multiple transmissions across multiple time intervals corresponding to the single control message. The communications manager 1720 may be configured as or otherwise support a means for transmitting, to the UE, a control message scheduling a set of multiple messages, the control message including a FDRA field and a TDRA field indicating a set of multiple frequency bands and one or more time intervals according to the time resource allocation table and the frequency resource allocation table. The communications manager 1720 may be configured as or otherwise support a means for communicating, via the set of multiple frequency bands and the one or more time intervals, the set of multiple messages with the UE according to the FDRA field and the TDRA field.

By including or configuring the communications manager 1720 in accordance with examples as described herein, the device 1705 may support techniques for scheduling multiple uplink shared channels across time and frequency, which may result in improved communication reliability, reduced latency, improved user experience, reduced processing, reduced power consumption, more efficient utilization of communication resources, and increased battery life, among other advantages.

In some examples, the communications manager 1720 may be configured to perform various operations (e.g., receiving, obtaining, monitoring, outputting, transmitting) using or otherwise in cooperation with the transceiver 1710, the one or more antennas 1715 (e.g., where applicable), or any combination thereof. Although the communications manager 1720 is illustrated as a separate component, in some examples, one or more functions described with reference to the communications manager 1720 may be supported by or performed by the transceiver 1710, the processor 1735, the memory 1725, the code 1730, or any combination thereof. For example, the code 1730 may include instructions executable by the processor 1735 to cause the device 1705 to perform various aspects of single DCI scheduling multiple uplink shared channels across time and frequency as described herein, or the processor 1735 and the memory 1725 may be otherwise configured to perform or support such operations.

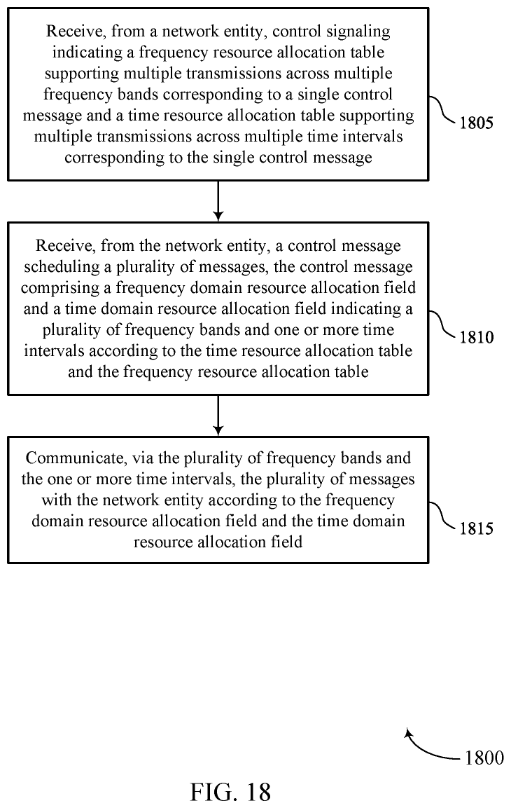

FIG. 18 shows a flowchart illustrating a method 1800 that supports single DCI scheduling multiple uplink shared channels across time and frequency in accordance with one or more aspects of the present disclosure. The operations of the method 1800 may be implemented by a UE or its components as described herein. For example, the operations of the method 1800 may be performed by a UE 115 as described with reference to FIGS. 1 through 13. In some examples, a UE may execute a set of instructions to control the functional elements of the UE to perform the described functions. Additionally, or alternatively, the UE may perform aspects of the described functions using special-purpose hardware.

At 1805, the method may include receiving, from a network entity, control signaling indicating a frequency resource allocation table supporting multiple transmissions across multiple frequency bands corresponding to a single control message and a time resource allocation table supporting multiple transmissions across multiple time intervals corresponding to the single control message. The operations of 1805 may be performed in accordance with examples as disclosed herein. In some examples, aspects of the operations of 1805 may be performed by a control signaling component 1225 as described with reference to FIG. 12.

At 1810, the method may include receiving, from the network entity, a control message scheduling a set of multiple messages, the control message including a FDRA field and a TDRA field indicating a set of multiple frequency bands and one or more time intervals according to the time resource allocation table and the frequency resource allocation table. The operations of 1810 may be performed in accordance with examples as disclosed herein. In some examples, aspects of the operations of 1810 may be performed by a control message component 1230 as described with reference to FIG. 12.

At 1815, the method may include communicating, via the set of multiple frequency bands and the one or more time intervals, the set of multiple messages with the network entity according to the FDRA field and the TDRA field. The operations of 1815 may be performed in accordance with examples as disclosed herein. In some examples, aspects of the operations of 1815 may be performed by a message communication component 1235 as described with reference to FIG. 12.

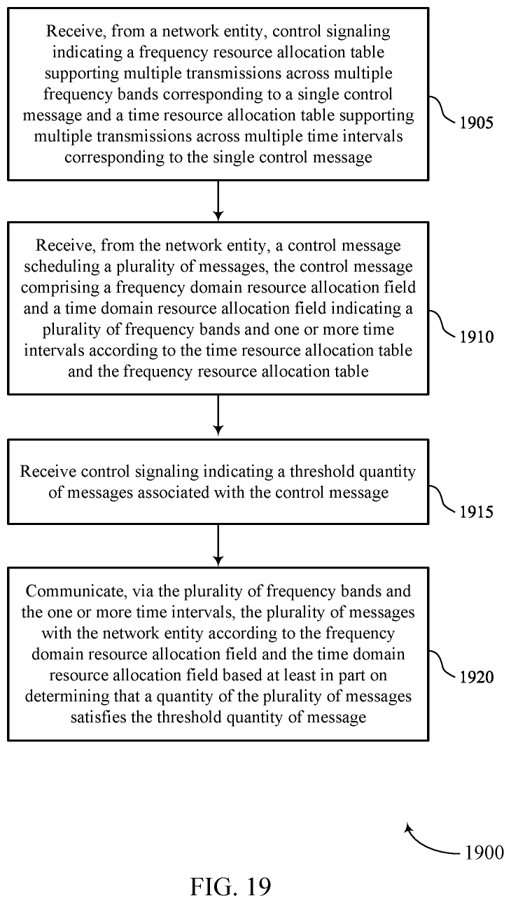

FIG. 19 shows a flowchart illustrating a method 1900 that supports single DCI scheduling multiple uplink shared channels across time and frequency in accordance with one or more aspects of the present disclosure. The operations of the method 1900 may be implemented by a UE or its components as described herein. For example, the operations of the method 1900 may be performed by a UE 115 as described with reference to FIGS. 1 through 13. In some examples, a UE may execute a set of instructions to control the functional elements of the UE to perform the described functions. Additionally, or alternatively, the UE may perform aspects of the described functions using special-purpose hardware.

At 1905, the method may include receiving, from a network entity, control signaling indicating a frequency resource allocation table supporting multiple transmissions across multiple frequency bands corresponding to a single control message and a time resource allocation table supporting multiple transmissions across multiple time intervals corresponding to the single control message. The operations of 1905 may be performed in accordance with examples as disclosed herein. In some examples, aspects of the operations of 1905 may be performed by a control signaling component 1225 as described with reference to FIG. 12.

At 1910, the method may include receiving, from the network entity, a control message scheduling a set of multiple messages, the control message including a FDRA field and a TDRA field indicating a set of multiple frequency bands and one or more time intervals according to the time resource allocation table and the frequency resource allocation table. The operations of 1910 may be performed in accordance with examples as disclosed herein. In some examples, aspects of the operations of 1910 may be performed by a control message component 1230 as described with reference to FIG. 12.

At 1915, the method may include receiving control signaling indicating a threshold quantity of messages associated with the control message. The operations of 1915 may be performed in accordance with examples as disclosed herein. In some examples, aspects of the operations of 1915 may be performed by a message threshold component 1245 as described with reference to FIG. 12.

At 1915, the method may include communicating, via the plurality of frequency bands and the one or more time intervals, the plurality of messages with the network entity according to the FDRA field and the TDRA field based at least in part on determining that a quantity of the plurality of messages satisfies the threshold quantity of message. The operations of 1915 may be performed in accordance with examples as disclosed herein. In some examples, aspects of the operations of 1915 may be performed by a message communication component 1235 as described with reference to FIG. 12.

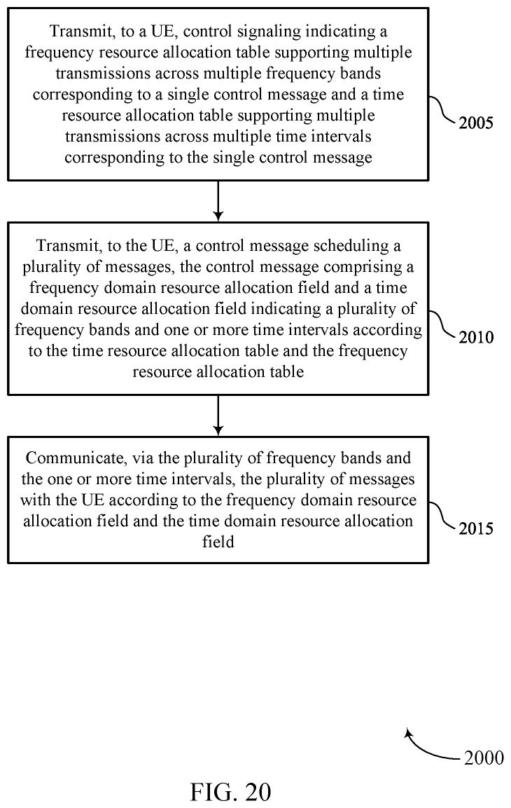

FIG. 20 shows a flowchart illustrating a method 2000 that supports single DCI scheduling multiple uplink shared channels across time and frequency in accordance with one or more aspects of the present disclosure. The operations of the method 2000 may be implemented by a network entity or its components as described herein. For example, the operations of the method 2000 may be performed by a network entity as described with reference to FIGS. 1 through 9 and 14 through 17. In some examples, a network entity may execute a set of instructions to control the functional elements of the network entity to perform the described functions. Additionally, or alternatively, the network entity may perform aspects of the described functions using special-purpose hardware.

At 2005, the method may include transmitting, to a UE, control signaling indicating a frequency resource allocation table supporting multiple transmissions across multiple frequency bands corresponding to a single control message and a time resource allocation table supporting multiple transmissions across multiple time intervals corresponding to the single control message. The operations of 2005 may be performed in accordance with examples as disclosed herein. In some examples, aspects of the operations of 2005 may be performed by a control signaling component 1625 as described with reference to FIG. 16.

At 2010, the method may include transmitting, to the UE, a control message scheduling a set of multiple messages, the control message including a FDRA field and a TDRA field indicating a set of multiple frequency bands and one or more time intervals according to the time resource allocation table and the frequency resource allocation table. The operations of 2010 may be performed in accordance with examples as disclosed herein. In some examples, aspects of the operations of 2010 may be performed by a control message component 1630 as described with reference to FIG. 16.

At 2015, the method may include communicating, via the set of multiple frequency bands and the one or more time intervals, the set of multiple messages with the UE according to the FDRA field and the TDRA field. The operations of 2015 may be performed in accordance with examples as disclosed herein. In some examples, aspects of the operations of 2015 may be performed by a message communication component 1635 as described with reference to FIG. 16.

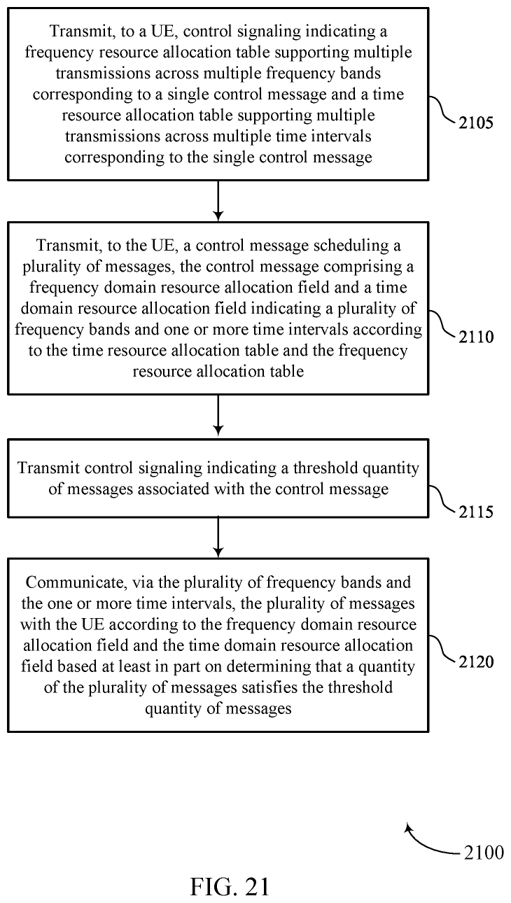

FIG. 21 shows a flowchart illustrating a method 2100 that supports single DCI scheduling multiple uplink shared channels across time and frequency in accordance with one or more aspects of the present disclosure. The operations of the method 2100 may be implemented by a network entity or its components as described herein. For example, the operations of the method 2100 may be performed by a network entity as described with reference to FIGS. 1 through 9 and 14 through 17. In some examples, a network entity may execute a set of instructions to control the functional elements of the network entity to perform the described functions. Additionally, or alternatively, the network entity may perform aspects of the described functions using special-purpose hardware.

At 2105, the method may include transmitting, to a UE, control signaling indicating a frequency resource allocation table supporting multiple transmissions across multiple frequency bands corresponding to a single control message and a time resource allocation table supporting multiple transmissions across multiple time intervals corresponding to the single control message. The operations of 2105 may be performed in accordance with examples as disclosed herein. In some examples, aspects of the operations of 2105 may be performed by a control signaling component 1625 as described with reference to FIG. 16.

At 2110, the method may include transmitting, to the UE, a control message scheduling a set of multiple messages, the control message including a FDRA field and a TDRA field indicating a set of multiple frequency bands and one or more time intervals according to the time resource allocation table and the frequency resource allocation table. The operations of 2110 may be performed in accordance with examples as disclosed herein. In some examples, aspects of the operations of 2110 may be performed by a control message component 1630 as described with reference to FIG. 16.

At 2115, the method may include transmitting control signaling indicating a threshold quantity of messages associated with the control message. The operations of 2115 may be performed in accordance with examples as disclosed herein. In some examples, aspects of the operations of 2115 may be performed by a message threshold component 1645 as described with reference to FIG. 16.

At 2120, the method may include communicating, via the plurality of frequency bands and the one or more time intervals, the plurality of messages with the UE according to the FDRA field and the TDRA field based at least in part on determining that a quantity of the plurality of messages satisfies the threshold quantity of messages. The operations of 2120 may be performed in accordance with examples as disclosed herein. In some examples, aspects of the operations of 2120 may be performed by a message communication component 1635 as described with reference to FIG. 16.

The following provides an overview of aspects of the present disclosure:

Aspect 1: A method for wireless communications at a UE, comprising: receiving, from a network entity, control signaling indicating a frequency resource allocation table supporting multiple transmissions across multiple frequency bands corresponding to a single control message and a time resource allocation table supporting multiple transmissions across multiple time intervals corresponding to the single control message; receiving, from the network entity, a control message scheduling a plurality of messages, the control message comprising a FDRA field and a TDRA field indicating a plurality of frequency bands and one or more time intervals according to the time resource allocation table and the frequency resource allocation table; and communicating, via the plurality of frequency bands and the one or more time intervals, the plurality of messages with the network entity according to the FDRA field and the TDRA field.

Aspect 2: The method of aspect 1, wherein receiving the control signaling comprises: receiving a RRC message comprising the frequency resource allocation table, wherein the FDRA field comprises an index indicating a row in the frequency resource allocation table associated with the plurality of messages.

Aspect 3: The method of aspect 2, wherein the row in the frequency resource allocation table associated with the index indicates one or more common parameters associated with communicating the plurality of messages via the plurality of frequency bands, one or more message-specific parameters associated with communicating each respective message of the plurality of messages via the plurality of frequency bands, or a combination thereof.

Aspect 4: The method of any of aspects 1 through 3, wherein receiving the control message comprises: receiving, in the FDRA field of the control message, an indication of the plurality of frequency bands that are associated with a first time interval of a plurality of time intervals comprising the one or more time intervals; and receiving, in the TDRA field of the control message, an indication of one or more remaining time intervals of the plurality of time intervals.

Aspect 5: The method of aspect 4, wherein communicating the plurality of messages comprises: communicating multiple messages of the plurality of messages via the plurality of frequency bands during the first time interval; and communicating a remaining one or more messages of the plurality of messages via a single frequency band of the plurality of frequency bands across the one or more remaining time intervals of the plurality of time intervals.

Aspect 6: The method of any of aspects 1 through 5, wherein receiving the control message comprises: receiving, in the FDRA field of the control message, an indication of the plurality of frequency bands that are associated with each of a plurality of time intervals comprising the one or more time intervals; and receiving, in the TDRA field of the control message, an indication of the plurality of time intervals.

Aspect 7: The method of aspect 6, wherein communicating the plurality of messages comprises: communicating the plurality of messages via the plurality of frequency bands during each of the plurality of time intervals.

Aspect 8: The method of any of aspects 1 through 7, further comprising: receiving control signaling indicating a threshold quantity of messages associated with the control message, wherein communicating the plurality of messages is based at least in part on determining that a quantity of the plurality of messages satisfies the threshold quantity of messages.

Aspect 9: The method of aspect 8, further comprising: dropping one or more messages of a total quantity of messages scheduled by the control message according to the threshold quantity of messages scheduled according to a prioritization of the total quantity of messages that is based on the one or more time intervals, the plurality of frequency bands, or a combination thereof.

Aspect 10: The method of aspect 9, wherein a first message occurring a first time offset after the control message has a higher priority level than a second message occurring a second time offset that is larger than the first time offset after the control message.

Aspect 11: The method of any of aspects 9 through 10, wherein a first message occurring a first time offset after the control message has a higher priority level than a second message occurring a second time offset that is shorter than the first time offset after the control message.

Aspect 12: The method of any of aspects 1 through 11, wherein communicating the plurality of messages with the network entity comprises: transmitting a plurality of uplink transmissions on an uplink shared channel.

Aspect 13: The method of any of aspects 1 through 12, wherein communicating the plurality of messages with the network entity comprises: receiving a plurality of downlink transmissions on a downlink shared channel.

Aspect 14: A method for wireless communications at a network entity, comprising: transmitting, to a UE, control signaling indicating a frequency resource allocation table supporting multiple transmissions across multiple frequency bands corresponding to a single control message and a time resource allocation table supporting multiple transmissions across multiple time intervals corresponding to the single control message; transmitting, to the UE, a control message scheduling a plurality of messages, the control message comprising a FDRA field and a TDRA field indicating a plurality of frequency bands and one or more time intervals according to the time resource allocation table and the frequency resource allocation table; and communicating, via the plurality of frequency bands and the one or more time intervals, the plurality of messages with the UE according to the FDRA field and the TDRA field.

Aspect 15: The method of aspect 14, wherein transmitting the control signaling comprises: transmitting a RRC message comprising the frequency resource allocation table, wherein the FDRA field comprises an index indicating a row in the frequency resource allocation table associated with the plurality of messages.

Aspect 16: The method of aspect 15, wherein the row in the frequency resource allocation table associated with the index indicates one or more common parameters associated with communicating the plurality of messages via the plurality of frequency bands, one or more message-specific parameters associated with communicating each respective message of the plurality of messages via the plurality of frequency bands, or a combination thereof.

Aspect 17: The method of any of aspects 14 through 16, wherein transmitting the control message comprises: transmitting, in the FDRA field of the control message, an indication of the plurality of frequency bands that are associated with a first time interval of a plurality of time intervals comprising the one or more time intervals; and transmitting, in the TDRA field of the control message, an indication of one or more remaining time intervals of the plurality of time intervals.

Aspect 18: The method of aspect 17, wherein communicating the plurality of messages comprises: communicating multiple messages of the plurality of messages via the plurality of frequency bands during the first time interval; and communicating a remaining one or more messages of the plurality of messages via a single frequency band of the plurality of frequency bands across the one or more remaining time intervals of the plurality of time intervals.

Aspect 19: The method of any of aspects 14 through 18, wherein transmitting the control message comprises: transmitting, in the FDRA field of the control message, an indication of the plurality of frequency bands that are associated with each of a plurality of time intervals comprising the one or more time intervals; and transmitting, in the TDRA field of the control message, an indication of the plurality of time intervals.

Aspect 20: The method of aspect 19, wherein communicating the plurality of messages comprises: communicating the plurality of messages via the plurality of frequency bands during each of the plurality of time intervals.

Aspect 21: The method of any of aspects 14 through 20, further comprising: transmitting control signaling indicating a threshold quantity of messages associated with the control message, wherein communicating the plurality of messages is based at least in part on determining that a quantity of the plurality of messages satisfies the threshold quantity of messages.

Aspect 22: The method of aspect 21, further comprising: dropping one or more messages of a total quantity of messages scheduled by the control message according to the threshold quantity of messages scheduled according to a prioritization of the total quantity of messages that is based on the one or more time intervals, the plurality of frequency bands, or a combination thereof.

Aspect 23: The method of aspect 22, wherein a first message occurring a first time offset after the control message has a higher priority level than a second message occurring a second time offset that is larger than the first time offset after the control message.

Aspect 24: The method of any of aspects 22 through 23, wherein a first message occurring a first time offset after the control message has a higher priority level than a second message occurring a second time offset that is shorter than the first time offset after the control message.

Aspect 25: The method of any of aspects 14 through 24, wherein communicating the plurality of messages with the UE comprises: receiving a plurality of uplink transmissions on an uplink shared channel.

Aspect 26: The method of any of aspects 14 through 25, wherein communicating the plurality of messages with the UE comprises: transmitting a plurality of downlink transmissions on a downlink shared channel.

Aspect 27: An apparatus for wireless communications at a UE, comprising a processor; memory coupled with the processor; and instructions stored in the memory and executable by the processor to cause the apparatus to perform a method of any of aspects 1 through 13.

Aspect 28: An apparatus for wireless communications at a UE, comprising at least one means for performing a method of any of aspects 1 through 13.

Aspect 29: A non-transitory computer-readable medium storing code for wireless communications at a UE, the code comprising instructions executable by a processor to perform a method of any of aspects 1 through 13.

Aspect 30: An apparatus for wireless communications at a network entity, comprising a processor; memory coupled with the processor; and instructions stored in the memory and executable by the processor to cause the apparatus to perform a method of any of aspects 14 through 26.

Aspect 31: An apparatus for wireless communications at a network entity, comprising at least one means for performing a method of any of aspects 14 through 26.

Aspect 32: A non-transitory computer-readable medium storing code for wireless communications at a network entity, the code comprising instructions executable by a processor to perform a method of any of aspects 14 through 26.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communications at a user equipment (UE), comprising:
a processor;
memory coupled with the processor; and
instructions stored in the memory and executable by the processor to cause the apparatus to:
receive, from a network entity, control signaling indicating a frequency resource allocation table supporting multiple transmissions across multiple frequency bands corresponding to a single control message and a time resource allocation table supporting multiple transmissions across multiple time intervals corresponding to the single control message;
receive, from the network entity, a control message scheduling a plurality of messages, the control message comprising a frequency domain resource allocation field and a time domain resource allocation field indicating a plurality of frequency bands and one or more time intervals according to the time resource allocation table and the frequency resource allocation table; and
communicate, via the plurality of frequency bands and the one or more time intervals, the plurality of messages with the network entity according to the frequency domain resource allocation field and the time domain resource allocation field.

2. The apparatus of claim 1, wherein the instructions to receive the control signaling are executable by the processor to cause the apparatus to:
receive a radio resource control message comprising the frequency resource allocation table, wherein the frequency domain resource allocation field comprises an index indicating a row in the frequency resource allocation table associated with the plurality of messages.

3. The apparatus of claim 2, wherein the row in the frequency resource allocation table associated with the index indicates one or more common parameters associated with communicating the plurality of messages via the plurality of frequency bands, one or more message-specific parameters associated with communicating each respective message of the plurality of messages via the plurality of frequency bands, or a combination thereof.

4. The apparatus of claim 1, wherein the instructions to receive the control message are executable by the processor to cause the apparatus to:
receive, in the frequency domain resource allocation field of the control message, an indication of the plurality of frequency bands that are associated with a first time interval of a plurality of time intervals comprising the one or more time intervals; and
receive, in the time domain resource allocation field of the control message, an indication of one or more remaining time intervals of the plurality of time intervals.

5. The apparatus of claim 4, wherein the instructions to communicate the plurality of messages are executable by the processor to cause the apparatus to:
communicate multiple messages of the plurality of messages via the plurality of frequency bands during the first time interval; and
communicate a remaining one or more messages of the plurality of messages via a single frequency band of the plurality of frequency bands across the one or more remaining time intervals of the plurality of time intervals.

6. The apparatus of claim 1, wherein the instructions to receive the control message are executable by the processor to cause the apparatus to:
receive, in the frequency domain resource allocation field of the control message, an indication of the plurality of frequency bands that are associated with each of a plurality of time intervals comprising the one or more time intervals; and
receive, in the time domain resource allocation field of the control message, an indication of the plurality of time intervals.

7. The apparatus of claim 6, wherein the instructions to communicate the plurality of messages are executable by the processor to cause the apparatus to:
communicate the plurality of messages via the plurality of frequency bands during each of the plurality of time intervals.

8. The apparatus of claim 1, wherein the instructions are further executable by the processor to cause the apparatus to:
receive control signaling indicating a threshold quantity of messages associated with the control message, wherein communicating the plurality of messages is based at least in part on determining that a quantity of the plurality of messages satisfies the threshold quantity of messages.

9. The apparatus of claim 8, wherein the instructions are further executable by the processor to cause the apparatus to:
drop one or more messages of a total quantity of messages scheduled by the control message according to the threshold quantity of messages scheduled according to a prioritization of the total quantity of messages that is based on the one or more time intervals, the plurality of frequency bands, or a combination thereof.

10. The apparatus of claim 9, wherein a first message occurring a first time offset after the control message has a higher priority level than a second message occurring a second time offset that is larger than the first time offset after the control message.

11. The apparatus of claim 9, wherein a first message occurring a first time offset after the control message has a higher priority level than a second message occurring a second time offset that is shorter than the first time offset after the control message.

12. The apparatus of claim 1, wherein the instructions to communicate the plurality of messages with the network entity are executable by the processor to cause the apparatus to:
transmit a plurality of uplink transmissions on an uplink shared channel.

13. The apparatus of claim 1, wherein the instructions to communicate the plurality of messages with the network entity are executable by the processor to cause the apparatus to:
receive a plurality of downlink transmissions on a downlink shared channel.

14. An apparatus for wireless communications at a network entity, comprising:
a processor;
memory coupled with the processor; and
instructions stored in the memory and executable by the processor to cause the apparatus to:
transmit, to a user equipment (UE), control signaling indicating a frequency resource allocation table supporting multiple transmissions across multiple frequency bands corresponding to a single control message and a time resource allocation table supporting multiple transmissions across multiple time intervals corresponding to the single control message;
transmit, to the UE, a control message scheduling a plurality of messages, the control message comprising a frequency domain resource allocation field and a time domain resource allocation field indicating a plurality of frequency bands and one or more time intervals according to the time resource allocation table and the frequency resource allocation table; and
communicate, via the plurality of frequency bands and the one or more time intervals, the plurality of messages with the UE according to the frequency domain resource allocation field and the time domain resource allocation field.

15. The apparatus of claim 14, wherein the instructions to transmit the control signaling are executable by the processor to cause the apparatus to:
transmit a radio resource control message comprising the frequency resource allocation table, wherein the frequency domain resource allocation field comprises an index indicating a row in the frequency resource allocation table associated with the plurality of messages.

16. The apparatus of claim 15, wherein the row in the frequency resource allocation table associated with the index indicates one or more common parameters associated with communicating the plurality of messages via the plurality of frequency bands, one or more message-specific parameters associated with communicating each respective message of the plurality of messages via the plurality of frequency bands, or a combination thereof.

17. The apparatus of claim 14, wherein the instructions to transmit the control message are executable by the processor to cause the apparatus to:
transmit, in the frequency domain resource allocation field of the control message, an indication of the plurality of frequency bands that are associated with a first time interval of a plurality of time intervals comprising the one or more time intervals; and
transmit, in the time domain resource allocation field of the control message, an indication of one or more remaining time intervals of the plurality of time intervals.

18. The apparatus of claim 17, wherein the instructions to communicate the plurality of messages are executable by the processor to cause the apparatus to:
communicate multiple messages of the plurality of messages via the plurality of frequency bands during the first time interval; and
communicate a remaining one or more messages of the plurality of messages via a single frequency band of the plurality of frequency bands across the one or more remaining time intervals of the plurality of time intervals.

19. The apparatus of claim 14, wherein the instructions to transmit the control message are executable by the processor to cause the apparatus to:
transmit, in the frequency domain resource allocation field of the control message, an indication of the plurality of frequency bands that are associated with each of a plurality of time intervals comprising the one or more time intervals; and
transmit, in the time domain resource allocation field of the control message, an indication of the plurality of time intervals.

20. The apparatus of claim 19, wherein the instructions to communicate the plurality of messages are executable by the processor to cause the apparatus to:
communicate the plurality of messages via the plurality of frequency bands during each of the plurality of time intervals.

21. The apparatus of claim 14, wherein the instructions are further executable by the processor to cause the apparatus to:
transmit control signaling indicating a threshold quantity of messages associated with the control message, wherein communicating the plurality of messages is based at least in part on determining that a quantity of the plurality of messages satisfies the threshold quantity of messages.

22. The apparatus of claim 21, wherein the instructions are further executable by the processor to cause the apparatus to:
drop one or more messages of a total quantity of messages scheduled by the control message according to the threshold quantity of messages scheduled according to a prioritization of the total quantity of messages that is based on the one or more time intervals, the plurality of frequency bands, or a combination thereof.

23. The apparatus of claim 22, wherein a first message occurring a first time offset after the control message has a higher priority level than a second message occurring a second time offset that is larger than the first time offset after the control message.

24. The apparatus of claim 22, wherein a first message occurring a first time offset after the control message has a higher priority level than a second message occurring a second time offset that is shorter than the first time offset after the control message.

25. The apparatus of claim 14, wherein the instructions to communicate the plurality of messages with the UE are executable by the processor to cause the apparatus to:
receive a plurality of uplink transmissions on an uplink shared channel.

26. The apparatus of claim 14, wherein the instructions to communicate the plurality of messages with the UE are executable by the processor to cause the apparatus to:
transmit a plurality of downlink transmissions on a downlink shared channel.

27. A method for wireless communications at a user equipment (UE), comprising:
receiving, from a network entity, control signaling indicating a frequency resource allocation table supporting multiple transmissions across multiple frequency bands corresponding to a single control message and a time resource allocation table supporting multiple transmissions across multiple time intervals corresponding to the single control message;
receiving, from the network entity, a control message scheduling a plurality of messages, the control message comprising a frequency domain resource allocation field and a time domain resource allocation field indicating a plurality of frequency bands and one or more time intervals according to the time resource allocation table and the frequency resource allocation table; and
communicating, via the plurality of frequency bands and the one or more time intervals, the plurality of messages with the network entity according to the frequency domain resource allocation field and the time domain resource allocation field.

28. The method of claim 27, wherein receiving the control signaling comprises:
receiving a radio resource control message comprising the frequency resource allocation table, wherein the frequency domain resource allocation field comprises an index indicating a row in the frequency resource allocation table associated with the plurality of messages.

29. The method of claim 28, wherein the row in the frequency resource allocation table associated with the index indicates one or more common parameters associated with communicating the plurality of messages via the plurality of frequency bands, one or more message-specific parameters associated with communicating each respective message of the plurality of messages via the plurality of frequency bands, or a combination thereof.

30. A method for wireless communications at a network entity, comprising:
transmitting, to a user equipment (UE), control signaling indicating a frequency resource allocation table supporting multiple transmissions across multiple frequency bands corresponding to a single control message and a time resource allocation table supporting multiple transmissions across multiple time intervals corresponding to the single control message;
transmitting, to the UE, a control message scheduling a plurality of messages, the control message comprising a frequency domain resource allocation field and a time domain resource allocation field indicating a plurality of frequency bands and one or more time intervals according to the time resource allocation table and the frequency resource allocation table; and
communicating, via the plurality of frequency bands and the one or more time intervals, the plurality of messages with the UE according to the frequency domain resource allocation field and the time domain resource allocation field.
